(19) United States
(12) Patent Application Publication
(10) Pub. No.: US 2006/0007189 A1
(43) Pub. Date: Jan. 12, 2006

(54) Forms-based computer interface

(76) Inventors: George L. Gaines III, Boxford, MA (US); Kevin K. Pang, Canton, MA (US); David Kent, Framingham, MA (US)

Correspondence Address: Norma E. Henderson, Esq.;Hinckley, Allen & Snyder LLP, 2nd floor, 43 North Main Street, Concord, NH, 03301-4934, US

(21) Appl. No.: 11/180,008

(22) Filed: Jul. 12, 2005

Related U.S. Application Data
(60) Provisional application No. 60/586,969, filed on Jul. 12, 2004.
(60) Provisional application No. 60/682,296, filed on May 19, 2005.

(51) Int. Cl. G09G 5/00; G06K 9/00; G06K 9/18

(52) U.S. Cl. 345/179; 382/186; 382/187; 382/188; 382/189

(57) ABSTRACT

A forms-based computer interface and method captures and interprets handwriting, pen movements, and other manual graphical-type user input for use in computerized applications and databases. An embodiment employs a portable Input and Control Device, a writing implement, and a host computing device that together capture, interpret, utilize, and store the handwriting, marks, and other pen movements of a user on and around predefined and identified forms. The Input and Control Device comprises a device for holding the predefined and identified forms and an e-clipboard for docking the holding device, capturing user input, and transmitting it to the host computing device for processing. Form, field, and user-specific handwriting and mark recognition are used in the interpretation of user input. An edit utility permits review and editing of the captured and interpreted input, permitting correction of capture and interpretation errors.

### RELATED APPLICATIONS

This application claims priority to U.S. Provisional Application Ser. No. 60/586,969, filed Jul. 12, 2004, and U.S. Provisional Application Ser. No. 60/682,296, filed May 19, 2005, both of which are herein incorporated by reference in their entirety.

### REFERENCE TO A COMPUTER PROGRAM LISTING APPENDIX SUBMITTED ON A COMPACT DISC

This application contains a computer program listing appendix submitted on compact disc under the provisions of 37 CFR 1.96 and herein incorporated by reference. The machine format of this compact disc is IBM-PC and the operating system compatibility is Microsoft Windows. The computer program listing appendix includes, in ASCII format, the files listed in Table 1:

TABLE 1

| | Creation | Size |
|---|---|---|
| File Name | Date | (Bytes) |
| AnalysisQueue.txt | 7/11/2005 | 13,308 |
| AnalysisResult.txt | 7/11/2005 | 4,661 |
| BMPFormHandler.txt | 7/11/2005 | 10,144 |
| BackendSimulatorStubs.txt | 7/11/2005 | 22,897 |
| BarcodeEmulator.txt | 7/11/2005 | 1,528 |
| BarcodeEmulatorHandler.txt | 7/11/2005 | 10,851 |
| BarcodeException.txt | 7/11/2005 | 1,437 |
| BarcodeReaderHandler.txt | 7/11/2005 | 32,581 |
| Base64.txt | 7/11/2005 | 51,616 |
| ChaincodeEngine.txt | 7/11/2005 | 1,468 |
| ClipBoardMessage.txt | 7/11/2005 | 5,783 |
| ClipBoardUtils.txt | 7/11/2005 | 26,738 |
| ClipboardConstants.txt | 7/11/2005 | 32,581 |
| CommandNotification.txt | 7/11/2005 | 1,222 |
| CommandQueueProcessor.txt | 7/11/2005 | 13,981 |
| CommandSimulator.txt | 7/11/2005 | 16,307 |
| Coordinate.txt | 7/11/2005 | 2,562 |
| DataConversion.txt | 7/11/2005 | 18,153 |
| DataHandler.txt | 7/11/2005 | 5,670 |
| Database.txt | 7/11/2005 | 9,605 |
| Database.xml.txt | 7/11/2005 | 5,097 |
| DebugBackendSimulator.txt | 7/11/2005 | 1,103 |
| DomToPenDocument.txt | 7/11/2005 | 7,303 |
| DummyTestPenImpl.txt | 7/11/2005 | 542 |
| EditElementInstance.txt | 7/11/2005 | 15,419 |
| ElementData.txt | 7/11/2005 | 4,383 |
| ElementData.xml.txt | 7/11/2005 | 1,752 |
| ElementDefinition.xml.txt | 7/11/2005 | 2,357 |
| ElementDefintion.txt | 7/11/2005 | 9,934 |
| ElementInstance.txt | 7/11/2005 | 9,043 |
| ElementInstance.xml.txt | 7/11/2005 | 2,141 |
| EnergyEngine.txt | 7/11/2005 | 1,517 |
| ExtractHWR.txt | 7/11/2005 | 2,563 |
| FormConversion.txt | 7/11/2005 | 5,971 |
| FormData.txt | 7/11/2005 | 11,174 |
| FormData.xml.txt | 7/11/2005 | 4,332 |
| FormDefinition.txt | 7/11/2005 | 17,154 |
| FormDefintion.xml.txt | 7/11/2005 | 2,423 |
| FormEditClient.txt | 7/11/2005 | 25,712 |
| FormHandler.txt | 7/11/2005 | 2,179 |
| FormHandlerFactory.txt | 7/11/2005 | 2,294 |
| FormInstance.txt | 7/11/2005 | 16,074 |
| FormInstance.xml.txt | 7/11/2005 | 2,829 |
| FormLoader.txt | 7/11/2005 | 10,893 |
| FormManager.txt | 7/11/2005 | 23,838 |
| GenericEngine.txt | 7/11/2005 | 4,483 |
| GenericExternalEngine.txt | 7/11/2005 | 11,989 |
| GraphicLocator.txt | 7/11/2005 | 5,740 |
| HTMLFormGenerator.txt | 7/11/2005 | 3,022 |
| HTMLFormHandler.txt | 7/11/2005 | 5,437 |
| HWR.xml.txt | 7/11/2005 | 4,766 |
| HWREngine.txt | 7/11/2005 | 1,254 |
| HWRFactory.txt | 7/11/2005 | 2,386 |
| HWRManager.txt | 7/11/2005 | 22,445 |
| ImageCanvas.txt | 7/11/2005 | 11,638 |
| ImageMarkEngine.txt | 7/11/2005 | 6,529 |
| InkDemoPen.txt | 7/11/2005 | 3,420 |
| InkMarkEngine.txt | 7/11/2005 | 1,889 |
| InkPanel.txt | 7/11/2005 | 1,503 |
| KyosFormHandler.txt | 7/11/2005 | 4,968 |
| Lexicon.xml.txt | 7/11/2005 | 6,025 |
| LexiconReader.txt | 7/11/2005 | 4,359 |
| LexiconTerm.txt | 7/11/2005 | 6,742 |
| LoadResource.txt | 7/11/2005 | 1,088 |
| Locator.txt | 7/11/2005 | 1,025 |
| LogitechV1Reader.txt | 7/11/2005 | 4,691 |
| MousePen.txt | 7/11/2005 | 1,840 |
| PDFFormHandler.txt | 7/11/2005 | 6,182 |
| Pen.txt | 7/11/2005 | 933 |
| PenButtonCapture.txt | 7/11/2005 | 4,261 |
| PenConfig.txt | 7/11/2005 | 5,321 |
| PenDocument.txt | 7/11/2005 | 19,856 |
| PenEvent.txt | 7/11/2005 | 1,230 |
| PenException.txt | 7/11/2005 | 823 |
| PenFactory.txt | 7/11/2005 | 2,906 |
| PenImpl.txt | 7/11/2005 | 3,312 |
| PenListener.txt | 7/11/2005 | 531 |
| PenParser.txt | 7/11/2005 | 732 |
| PenReader.txt | 7/11/2005 | 2,113 |
| PenTranslator.txt | 7/11/2005 | 6,277 |
| RetrieveBackendItems.txt | 7/11/2005 | 4,055 |
| SVGFormHandler.txt | 7/11/2005 | 5,816 |
| SVGReader.txt | 7/11/2005 | 2,963 |
| Saveable.txt | 7/11/2005 | 564 |
| ScrollablePicture.txt | 7/11/2005 | 3,547 |
| SelectionBox.txt | 7/11/2005 | 654 |
| SelectionListener.txt | 7/11/2005 | 454 |
| SerialReadTest.txt | 7/11/2005 | 7,290 |
| SerialWriteTest.txt | 7/11/2005 | 3,483 |
| SetClipBoardBaudRate.txt | 7/11/2005 | 18,431 |
| SimpleWebTest.txt | 7/11/2005 | 5,660 |
| SqlMapConfig.xml.txt | 7/11/2005 | 2,529 |
| SqlMapConfigTest.properties.txt | 7/11/2005 | 482 |
| SqlmapConfig.properties.txt | 7/11/2005 | 477 |
| Startup.properties.txt | 7/11/2005 | 508 |
| Startup.txt | 7/11/2005 | 1,708 |
| Stroke.txt | 7/11/2005 | 14,034 |
| TrainedSample.txt | 7/11/2005 | 7,533 |
| TrainedWord.txt | 7/11/2005 | 8,824 |
| Trainer.txt | 7/11/2005 | 16,733 |
| TrainingSet.txt | 7/11/2005 | 5,460 |
| User.txt | 7/11/2005 | 3,105 |
| User.xml.txt | 7/11/2005 | 1,511 |
| ViewFormData.txt | 7/11/2005 | 3,062 |
| Visit.txt | 7/11/2005 | 8,693 |
| Visit.xml.txt | 7/11/2005 | 3,784 |
| VisitForm.txt | 7/11/2005 | 4,707 |
| VisitManager.txt | 7/11/2005 | 5,851 |
| Visitmanager1.txt | 7/11/2005 | 817 |
| WebFinishRunnable.txt | 7/11/2005 | 1,929 |
| WebServiceConnector.txt | 7/11/2005 | 7,235 |
| WebServiceConnectorFactory.txt | 7/11/2005 | 3,179 |
| WebServiceConnectorLocal.txt | 7/11/2005 | 9,511 |
| WebServiceConnectorRemote.txt | 7/11/2005 | 37,398 |
| WebStatusReturn.txt | 7/11/2005 | 3,244 |
| XMLObject.txt | 7/11/2005 | 8,106 |
| formTypes.properties.txt | 7/11/2005 | 1,787 |
| hwrimpl.properties.txt | 7/11/2005 | 425 |
| keepAliveTimer.txt | 7/11/2005 | 7,876 |
| lexicon.txt | 7/11/2005 | 6,038 |
| package.html.txt | 7/11/2005 | 5,140 |

### FIELD OF THE INVENTION

The invention relates to human-computer interfaces and, in particular, to a forms-based computer interface that captures and interprets handwriting, pen movements, and other manual graphical-type input.

### BACKGROUND

The term “workflow” typically is used to refer to the actions that are taken by a person while accomplishing a task. Such a task may be of short duration with few, if any, complicated actions, or it may be of long duration, having many complicated actions. Often, during the accomplishment of a task or set of tasks, data needs to be gathered, received, collected and stored. Ideally, the acquisition, collection and storage of information during a workflow should occur at the appropriate time with a minimal amount of effort or disruption to the other actions in the workflow. However, despite the advances in computing, computer-driven data acquisition, and information retrieval that have occurred during recent years, certain information-intensive workflows have not benefited as hoped. Generally, these workflows require, as some or all of their tasks, manual actions that must be performed by the person engaged in the workflow and that are frequently highly variable. Examples of such workflows include examining, diagnosing, and treating a patient by a physician, various workflows in inventory management and quality assurance, and educational workflows, including the monitoring of a particular student's progress, interacting with students in a flexible manner, and the testing of students. Furthermore, many activities that may not be considered workflows, such as those involving the creation of artwork, have also yet to truly benefit from computer technology.

One of the major barriers to incorporation of computational advances in these workflows has been the interface between the user and the computer, generally referred to as the Human-Computer Interface. Data collection by standard computer interfaces hampers workflow in situations where the cognitive focus of the data collector needs to be on objects other than the computer interface. Often the keyboard and mouse data entry and computer control paradigm is not appropriate for those workflows, due to the need for the user's attention and activity during the data entry and manipulation. This is particularly evident in tasks that require personal intercommunication, such as the doctor-patient interview process during an exam. Human-computer interfaces that require the physician to focus on a screen with complicated mouse and keyboard manipulations for data entry dramatically interrupt the interaction with the patient. Furthermore, any manipulations of input devices that require removal of gloves, for sterility or dexterity reasons, dramatically impact the doctor-patient interview.

In addition, such workflows are often badly served by secondary input scenarios, such as where paper forms are scanned after the fact, because there is then no real-time opportunity for detection and correction of errors, illegible information, or requests for additional information needed to accompany the original input. This problem might occur, for example, where a doctor has entered a prescription and omitted a dosage or prescribed a non-standard dosage level, when the identity of the drug being prescribed is not legible, where the patient's record indicate that the particular drug being prescribed is not recommended with another medication already being taken by the patient, or when the medication dose must be keyed to some factor not available in the record, such as the patient's current weight. In the secondary input scenario, steps must then be taken to track down the doctor, and possibly even the patient, in order to rectify omissions or errors that could easily have been avoided in a real-time entry situation.

It is known that handwritten or hand-drawn input can often be more convenient to use than a keyboard and, in many cases, may be more appropriate for certain types of communication. Many written language systems, such as Japanese, Korean, Chinese, Arabic, Thai, Sanskrit, etc., use characters that are very difficult to input into a conventional computational system via keyboard. For example, text input of the Japanese written language requires the use of simulated phonetic spelling methods (romanji, hiragana, and/or katakana) to select from thousands of possible kanji characters.

Further, many mobile devices, such as PDAs and mobile phones, have, at best, limited keyboards due to their limited size and form, or would become cumbersome to use if a keyboard must be attached or if text must be entered by softkeys or graffiti. In addition, people who have limited hand mobility because of injury (including repetitive stress injuries from keyboard use), illness, or age-related diseases, may not be able to use a keyboard effectively. Current legal and financial institutions also still rely heavily on the use of handwritten signatures in order to validate a person's unique identity. In many instances, it is simply much easier to communicate an idea by drawing an annotated picture. Finally, many people prefer handwriting or drawing a picture as being a more personal or expressive communication method than typing text on a keyboard. Therefore, mechanisms that use handwriting, drawing, or painting as inputs to computing devices have distinct advantages in many applications over standard keyboard and mouse input devices.

The ability of a writing device to act as an interface into a computer is generally limited by the user's ability to provide directions and understandable data to the computer. The current popular interfaces using mouse-based control rely on the computer “understanding” where the user is pointing, i.e. where the focus of the mouse actions are in a relative x,y space on the screen to the mouse position on a surface. The use of touch screens, either with a pen device or fingertips, provides a direct location for the user's input. Advanced writing and drawing tablets, such as a Wacom tablet, provide a means to move a pointer about the screen using a relative x,y dimension between the screen and the tablet, as well as a writing means. Through the x,y location, the computer is able to “understand” the commands of the user, as implemented through drop down menus, dialog boxes, and the like.

In order for any computing device to be of utility to a person, it needs to have an input and output capability with an appropriate level of “user friendliness”. Currently, the output vehicle usually utilizes a visual display of information, although devices exist for the output of information in the form of sound or other stimuli. The visual output, depending on the complexity of the data to be observed, may be produced by such devices as, for example, CRTs, 7 segment displays, LCD displays, and Plasma displays. The decision to use a particular display for a specific application is typically based on, for example, the complexity of the data to be displayed, cost, ease of use, and size needed.

The input of data from the user to the computing device occurs in numerous ways, through several device types, and again is defined by the needs of the person inputting information and the complexity of the data. For example, simple data entry of numbers may be accomplished using a keypad, whereas the storing and archiving of high resolution photographs requires high speed data transfer between or among digital camera storage devices and the computing device. In situations where the user is responding or directing his/her input dependent upon the cues from the computing device, several input approaches are available. For example, joy sticks are popular with “gamers”, where rapid response to the output stimuli is required, whereas the entry of personal data into a questionnaire may be accomplished using a keypad, mouse or microphone, with the appropriate voice recognition software.

One flexible and user-friendly device for inputting information is the touchpad. This device type allows the user to put data into a computing or storage device via manipulations of a digit or some writing implement that does not require specialized training, such as may be required to develop efficient typing or mouse manipulation skills. This input device type generates data from the physical touching of the surface, such as occurs with the use of a pen in handwriting or in moving a cursor to a scroll bar. However, these devices have restricted utility in data entry, handwriting capture, or the like, due to their small size and, in general, limited spatial resolution.

Another means for input of information that does not require typing skills is through paper-based pen handwriting systems, such as the Logitech io™ personal digital pen, the PC Notes Taker by Pegasus Technologies Ltd., and the Seiko Instruments InkLink™ handwriting system. Although the means by which the pen location is provided is different, all of these systems provide the computer with coordinates of the writing implement over time. The Logitech device captures the spatial information via reflectance of proprietary printed dots on the paper, and then stores the information until downloaded by docking the pen device, whereas the InkLink™ and the PC Notes Taker systems provide pen location in real time through infrared and ultrasound triangulation and sensing.

A further combination of both input and output devices has been developed, utilizing a touchscreen mechanism. In this device, the screen output and the user interface input resides on the same screen, with writing on the screen registering as the user input. This approach has recently become very popular in the forms of PDAs, operating with character recognition based on the Palm™ Graffiti program, in tablet computers with more sophisticated character recognition, or in kiosks, with the touch screen inputs being limited to the user being able to choose specific functions or topics on menus. All of these devices have as part of their capabilities both input/output functions, as well as processing, data storage, and programming capabilities.

Currently, no publicly available system combines the attributes of a paper/pen-based system of writing capture and the specificity of form-based input with the functionality of a true real-time input device that allows significant control of the computer. What has been needed, therefore, is a forms-based real-time human-computer interface that combines handwriting interaction and touch screen-like input capabilities to provide for interactive data entry and control tasks that have previously required keyboard or mouse input.

### SUMMARY

The present invention is in one aspect a forms-based computer interface that captures and interprets handwriting, pen movements, and other manual graphical-type input in order to obtain the information conveyed for use in database and other applications. In another aspect, the present invention is a method for automatically capturing pen-based inputs, recognizing and interpreting those inputs to determine the information content being conveyed, and using those inputs to populate a computer information database with the conveyed information. The need for accessing information, collecting and assimilating data, and acting upon the resulting data and information during the actual workflow process is addressed by the present invention through the creation of user-friendly computational input and control mechanisms that employ handwriting and pen movement for both data entry and computer-control functions.

The present invention provides a process and an interface device that allow data input, application control, graphical environment generation, and information retrieval for interactions with computational devices. In particular, the present invention is a process and interface device that utilizes a writing, drawing, or painting implement and paper forms to accomplish those tasks through wired or wireless connections to the computing devices. In one aspect, the present invention provides for the input and supplying of interactive and changeable information and content as a computational interface for a user or multiple users. The user input can be in whole or in part through handwriting, drawing, and/or painting on paper or other surfaces. In one embodiment of the invention, the user can change the page upon which he/she is writing or drawing and the system will recognize and respond to the change.

In a preferred embodiment, the hardware consists of an input and control device (ICD) that acts as the interactive interface for the user and has a means to communicate the location and movement of a writing, drawing, or painting implement to the computational device or other host, such as a computer, PDA, cell phone or the equivalent. The software, running in part as firmware on the ICD and/or as programs on the computing device, at a minimum records the position and movement of the writing (drawing/painting) implement, and may optionally also record user identification information and time of input. Other applications and software used in the process may include Optical Character Recognition (OCR) for machine text recognition, Intelligent Character Recognition (ICR) to decipher simple alpha and numeric handwritten strokes, and even print and cursive handwriting (HWR), possibly coupled with a delimited vocabulary set, and Optical Mark Recognition (OMR) to detect check marks and lines in fields or boxes, a forms generation and storage system to capture and store handwriting, drawing, or painting on forms and documents, appropriate application programming interfaces (APIs), form identification capabilities, such as barcode printing and scanning software, drivers for screens, standard word and diagram processing software, browsers, and the like. The system of the present invention can be used to store, archive, and retrieve thusly generated images, diagrams, handwriting, painting and other input information. Furthermore, in this invention, the writing device, through its position on the surface of the ICD is able to control the host computing device.

### BRIEF DESCRIPTION OF THE DRAWINGS

FIG. 1 is a flow chart of the operation of one aspect of an example embodiment of the present invention, showing the steps for input, capture, and processing of a single user form entry;

FIG. 2 is a block diagram of an example embodiment of the present invention, showing the functional relationships between the system components;

FIG. 3 is a flow chart of the overall operation of an example system according to the present invention;

FIG. 4 is a diagram depicting information flow among the components of an embodiment of the present invention;

FIG. 5 is a flow chart of the process of entering and defining a new form according to one aspect of an embodiment of the present invention;

FIG. 6 is a flow chart of the process of printing out a defined form with an identifier according to one aspect of an embodiment of the present invention;

FIG. 7 is a flow chart of the process of detecting which form type is being currently used according to one aspect of an embodiment of the present invention;

FIG. 8 flow chart of the process of detecting pen writing/drawing strokes according to one aspect of an embodiment of the present invention;

FIG. 9 is an example paper stack showing the x,y,z axes utilized by the process of FIG. 8;

FIG. 10 is an example showing x,y triangulation according to the process of FIG. 8;

FIG. 11 is flow chart of the process of capture and transmission or storage of writing or drawing on a form according to one aspect of an embodiment of the present invention;

FIG. 12 is flow chart of the processing of hotspot commands generated by pen position according to one aspect of an embodiment of the present invention;

FIG. 13 is flow chart of the general process of field- and form-specific recognition according to one aspect of an embodiment of the present invention;

FIG. 14 is flow chart of the process of field-specific mark recognition according to one aspect of an embodiment of the present invention;

FIG. 15 is flow chart of the process of user- and field-specific handwriting recognition according to one aspect of an embodiment of the present invention;

FIG. 16 is flow chart of the process of editing machine interpretations of entries according to one aspect of an embodiment of the present invention;

FIG. 17 depicts an example implementation of an Input and Control Device according to one aspect of the present invention;

FIGS. 18A and 18B are front and back views, respectively, of an example implementation of a PaperPlate for the Input and Control Device of FIG. 17;

FIGS. 19A and 19B are front and uncovered (housing removed) views, respectively, of an example implementation of an e-clipboard for the Input and Control Device of FIG. 17;

FIG. 19C is a side view of the e-clipboard of FIGS. 19A and 19B and the PaperPlate of FIGS. 18A and 18B;

FIGS. 20A and 20B depict insertion of the PaperPlate of FIGS. 18A and 18B into the e-clipboard of FIGS. 19A and 19B in the Input and Control Device of FIG. 17;

FIGS. 21A and 21B are side and top views, respectively, of an example implementation of a bar code reader for use in an embodiment of an Input and Control Device according to the present invention;

FIG. 22 is a depiction of the light path of the bar code reader of FIGS. 21A and 21B;

FIG. 23 is flow chart of the process of page recognition and timing with pen movement according to one aspect of an embodiment of the present invention;

FIG. 24 is a depiction of an example form on a PaperPlate according to one aspect of the present invention;

FIG. 25 is flow chart of the process of developing and storing form and application-specific lexicons according to one aspect of an embodiment of the present invention;

FIG. 26 is flow chart of the process of training a computer to recognize a user's handwriting according to one aspect of an embodiment of the present invention;

FIG. 27 is a screen shot of an example visual display that may be seen by a user during normal data capture operation of the present invention;

FIG. 28 is a screen shot of another example visual display that may be seen by a user during normal data capture operation of the present invention;

FIG. 29 is a screen shot of a further example visual display that may be seen by a user during normal data capture operation of the present invention;

FIG. 30 is a screen shot of an example form definition screen according to one aspect of the present invention;

FIG. 31 is a screen shot of an example user login screen for training the computing device to recognize a user's handwriting according to one aspect of the present invention;

FIG. 32 is a screen shot of an example screen during training of the computing device to recognize a user's handwriting according to one aspect of the present invention; and

FIG. 33 is a screen shot of an example visual display that may be seen by a user during editing of the captured and interpreted data.

### DETAILED DESCRIPTION

The present invention is in one aspect a forms-based computer interface that captures and interprets handwriting, pen movements, and other manual graphical-type input. The preferred embodiment of a system of the present invention employs a portable Input and Control Device (ICD), a writing implement (WI), and a host computing device that are used together to capture and interpret the handwriting, marks, and other pen movements of a user on and around predefined and identified forms, in order that the entries made on the forms be automatically entered into a computer database. In a preferred embodiment, the ICD comprises two main parts, a “PaperPlate” for holding one or more of the predefined and identified forms and an “e-clipboard” for docking the PaperPlate, capturing the user input, and transmitting the user input to the host computing device for processing. In another aspect, the present invention is a method for automatically capturing pen-based inputs, recognizing and interpreting those inputs to determine the information content being conveyed, and using those inputs to populate a computer information database with the conveyed information.

In the present invention, the use of a handwritten input, forms based approach requires that certain aspects of computer control be decoupled from the relative x,y position during writing, thereby allowing the pen to act as both a writing implement and a human computer interface input device, similar to a mouse and/or the arrow keys on a keyboard. In one embodiment of the invention, the written or drawn input on the paper, as captured by the device, allows a coupling of data input with computer control, so that the computer response is tailored to the input of the user. The control of the computer using a writing implement is implemented in one embodiment through the use of defined virtual “hotspots” and the dynamic generation of hotspots based on use case and user. In this embodiment, the device has virtual hotspots that are activated by tapping or pressing of the writing device on the paper or on the Input and Control Device (ICD) surface at those hotspot locations. The activation of the virtual hotspot sends signals to the host computer, allowing a variety of command and control processes to occur. The virtual hotspot technology in many instances replaces the standard mouse click command and control processes in a mouse-driven computer interface.

In one embodiment, the ICD contains a mechanism to locate and monitor the position of a writing, drawing, or painting implement (WI) when it is in contact (writing, drawing, painting, or pointing) with a page of paper or other surface and has the ability to transmit (through wires or wirelessly) the resulting data to a computing device, such as, but not limited to, a tablet, laptop, server, and desktop computer or a PDA as standalone or networked devices. In addition, the ICD has the means to recognize the specific piece of paper or surface (page or form) with which the WI is in contact. In the preferred embodiment, this is accomplished through a barcode scanner within the ICD and a barcode printed on each piece of paper or surface, but any other suitable device or process known in the art may be advantageously employed. Optionally, the user's identity and time of use may be captured by the ICD, via a log in, signature, biometric device or other means. The paper or form identification allows the computation device to know upon which page or form the user is writing or contacting and when this is occurring. The combination of the location and contact of the WI, the specific page and time, and the identification of the user, allows the computing device to integrate important information into an interactive file that can be stored, analyzed and retrieved.

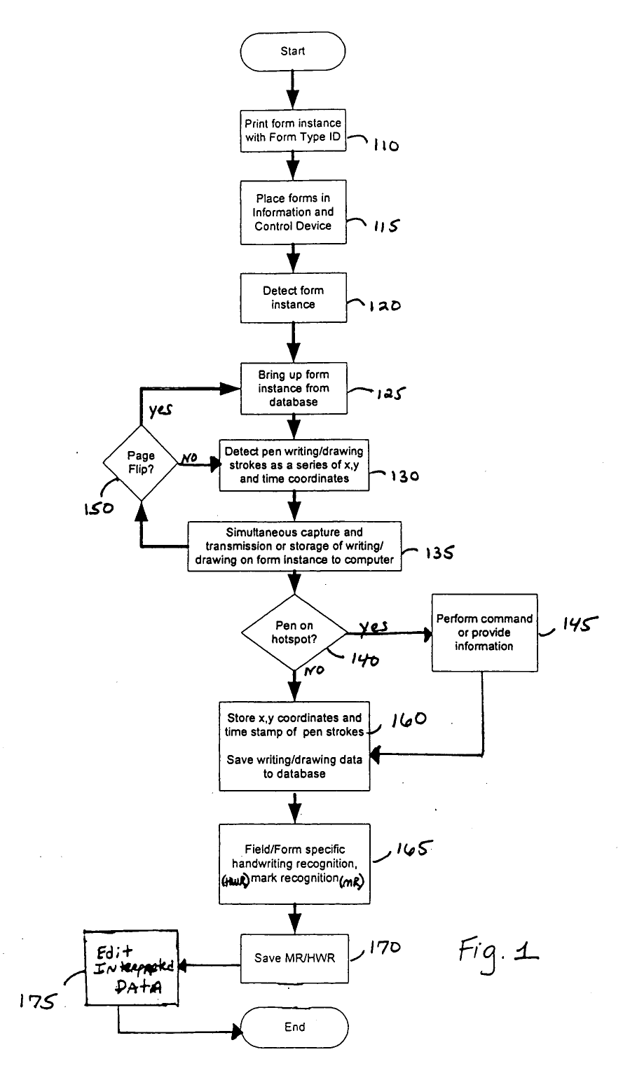

FIG. 1 is a flow chart of the operation of one aspect of an example embodiment of the method of the present invention, showing the steps for input, capture, and processing of a single user form entry. As shown in FIG. 1, a form is printed with a Form Type ID 110. The user brings up the appropriate form template on the computer and attaches an identifying number or code to the form either manually or via the computer, thereby rendering it a specific form instance. In the currently preferred embodiment, the computer automatically assigns a barcode ID to the form instance, as well as attaching other information to the form instance. For example, this information might be the time of adding the barcode ID, the patient or person whom which the form instance refers, the office or location of the user, and other pertinent sets of data. The user then prints out the form instance complete with any entered data, as well as the barcode specifically identifying the form instance. Next, the forms are placed 115 in the ICD and the device detects 120 the specific form instance, causing it to call up 125 the information about that form instance from the database.

The next step is the detection 130 of the user's pen writing/drawing strokes as a series of x,y and time coordinates. The detection of the user's handwriting or drawing may be accomplished in any of the many ways familiar to one of ordinary skill in the art. In the preferred embodiment, the position of the pen contacting the form instance is captured in the x,y plane over time as a series of x,y points and the relative time at which the pen was in a specific x,y position (x,y,t). Hence in one embodiment, the position of the pen may be sampled at a consistent time interval, for example at 100 Hz., to provide sufficient positional information to reconstruct the movement over time. It has been found that 60-100 Hz (or higher) is sufficient to provide useful data that can be used to reconstitute the pen movement in a detailed way, as well as provide the needed input for handwriting recognition.

The pen movement on the specific form instance is captured 135 as a series of x,y,t coordinates and either electronically saved or directly transmitted to a computer for display, analysis or storage. Depending upon the application, the electronic pen data is handled in different ways. In the present embodiment, the pen data is sent directly by means of a cable or wirelessly to a computer where it can be displayed. In addition, the use of hotspots and virtual hotspots by the user is then enabled. The hotspot and virtual hotspot capability allows the user to access other materials on the computer, as well as upon finishing all or part of the form instance data entry, control the saving of input to the database. If the wiring implement is on a hotspot 140, then the predefined command for that form instance is performed or the predefined information is displayed 145.

If the user so chooses, he/she may use more than one form instance at a time. The means for the e-clipboard to recognize if and when a page has been flipped 150 occurs through the recognition of the form type ID, which in the preferred embodiment is a barcode. Therefore the changing of pages for input results in the system recognizing 150 the change and linking the pen input to the form instance upon which the user is now writing by calling up 125 the new form instance. The form instance, if part of a larger set, may be optionally automatically placed in memory on the host computer, thereby not requiring a call to the database with every page flip.

Upon finishing the input of a portion or a complete form instance or group of form instances, the input, including the form type IDs and the handwriting input is saved 160 to a database. Field/Form specific handwriting recognition and mark recognition 165 is then performed on the captured and saved data, thereby producing a machine interpretation of the input. The handwriting data, including check marks, circles or other appropriate annotations as well as writing of letters, numbers and words or the like may be analyzed in real time by a computing device, or may be stored in the database until a later date. The analysis may consist of mark recognition, thereby identifying check marks, circles, and the like in fields that are specially designated as mark recognition fields, as well as handwriting recognition, which may be performed in real time or at a later date using handwriting recognition algorithms including character, figure, graphics and word recognition algorithms. In the preferred embodiment, the handwriting recognition is simplified through the use of user and field specific lexicons and user input as training of the recognition algorithms.

The output of the handwriting recognition and mark recognition algorithms is linked to the raw handwriting input, as well as to the form instance and user ID, and may be saved 170 for further use or processing. Furthermore, the date, time and location data may be linked as well. In this manner, the database entries for the input provide a complete audit trail. Both the original input of the handwriting and the machine interpretation may then be edited 175. Furthermore, all edits may be tracked with time and date stamping, location and machine stamping, as well as the user identification during editing input. The edited material may then be optionally saved to the database for later dissemination or printing.

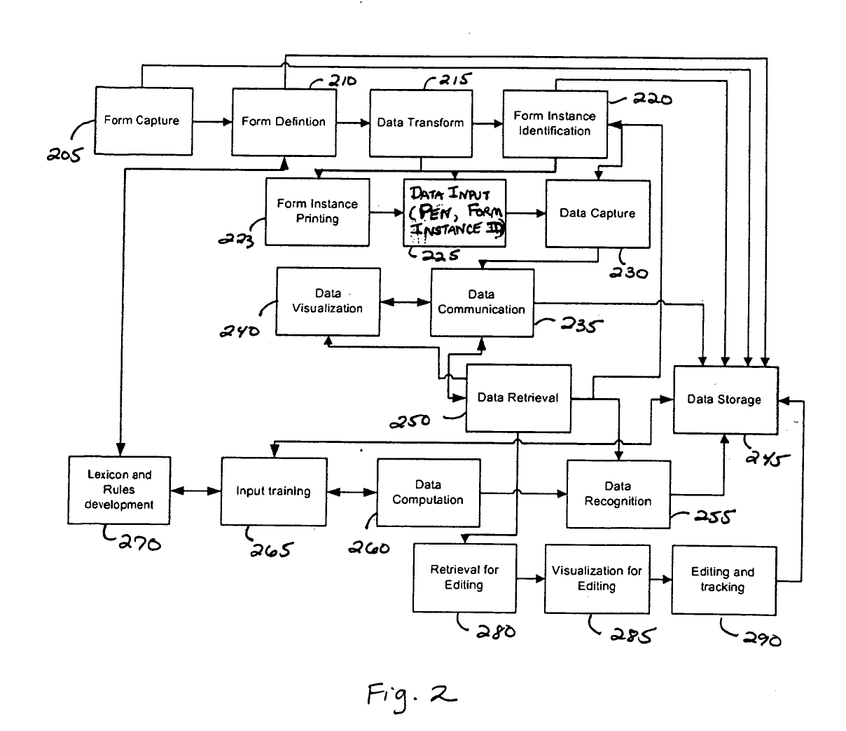

The major functions accomplished by present invention include the input and defining of the forms and the fields within the forms, the capture of data using a handwriting-based system, communication of that data to a computational device, visualization of the captured data, as well of other types of data, storage and retrieval of the captured data, machine interpretation or recognition of the data, including handwriting recognition and mark recognition, and an editing function that allows user manipulation of the input data and the machine interpreted data. FIG. 2 is a block diagram of an example embodiment of the present invention, showing the functional relationships between the system components.

In FIG. 2, form capture function 205 includes, but is not limited to, standard means for inputting a form into an electronic format, such as scanning in a paper form copy, providing an electronic version of a form, faxing and capturing the faxed copy, and building a form electronic form using standard word processing, form generating or image processing software, such as Microsoft word, Microsoft Visio, Microsoft InfoPath, and OpenOffice. Form definition function 210 allows a user to describe the form as a set of fields within the form template that have attributes of location, name, and input type, as well as possibly having the attributes of field-specific lexicons for recognition and validation rules for input. Data transformation function 215 allows, when necessary, the conversion of form templates to different MIME types for printing, storage, and ease of visualization. Form instance identification function 220 is identifies and tags each specific form instance with a unique identifier, such as a number, a barcode, or any other means that can be easily and quickly detected on the paper.

The printing 223 of form instances may be accomplished using a variety of printing devices. Aside from accurately reproducing the form instance, the printing device or a secondary device ideally will attach or print the unique identifier to the form instance such that the reading device on the e-clipboard can easily and quickly detect its presence at the surface of the stack upon which pen data is being deposited. Alternatively, the form type ID may be attached manually by the user. Data input function 225 is activated by the user's pen movement. Any of the many commercially available devices may be used to capture pen movement on paper, such as the Anoto pen and the Pegasus Notetaker system. Alternatively, or in addition, the paper may be laid on top of magnetic induction capture devices, such as the Wacom tablets, thereby providing x,y and time data for pen movement. Among other activities, data input function 225 obtains the unique form identifier. Data Capture 230 of the input data occurs as the various input devices are operating. The data is assembled and moved to a data communications chip for sending to a computing device or directly for storage in a storage device.

After the data is captured 230, it is moved directly to a communications device for transfer to another computing device e.g., server, or a storage device. Data communication function 235 sends the captured data to the appropriate locations. Data visualization function 240 allows for both real time viewing of the pen input and form instance in register, as well as older data that was captured by the system or comes from other sources. Visualization may also be part of offline data mining. Date storage function 245 stores the data generated via form definition function 210, data capture function 230, and the recognition and editing functions to a database, such as MySQL, Access, PostGreSQL, Oracle or others. This data is retrieved through data retrieval function 250.

Recognition function 255 allows the user input, such as writing, marking or drawing to be transformed by data computation function 260 into a machine interpretable patterns, such as machine text, Boolean options, true/false, or other computer recognizable alphanumeric characters. In the preferred embodiment, the recognition algorithms function significantly better with limited choices. Hence, field-specific lexicons or inputs may be employed, thereby drastically reducing the number of words, phrases, shapes, and the like that need to be interpreted. Through input training function 265, the user-specific handwriting and drawing further provides a limit on the number, type, and diversity of inputs that the function is required to recognize. Lexicon and rules development function 270 allows the user to define the lexicons for the specific fields. In addition, validation rules may be implemented for specific fields that further restrict the entry set for a specific field.

Input Training 265 may occur prior to the filling out of forms and provides the recognition engines with actual writing samples against which they will compare the pen input. In addition, input by a user on form instances may be used to evolve the training set that is used by the recognition engines. Data computation 260 may further be used to define the optimal training set, or to evolve the training set as the user's writing or inputs change. For example, through analytical approaches, the number of training examples for each word or phrase in a lexicon may be reduced without losing recognition accuracy.

The input data, where specified by the form definition, is recognized 255 to produce machine text, Boolean operators, or image identification output for storage and data manipulation. There are a number of commercially and open source handwriting recognition packages that may be used. In the preferred embodiment, several approaches have been incorporated and are being optimized to achieve high levels of recognition accuracy with reasonable efficiency, including Chain code recognition, energy minimization recognition, and pen velocity recognition. The editing functions allow a user to retrieve 280 a pen input form instance and, when applicable, the machine interpreted form instance for viewing 285 and editing 290 of inputs. The edited form instances are then saved to the database, in general with new attributes that indicate the user that did the editing, the time and location of the editing.

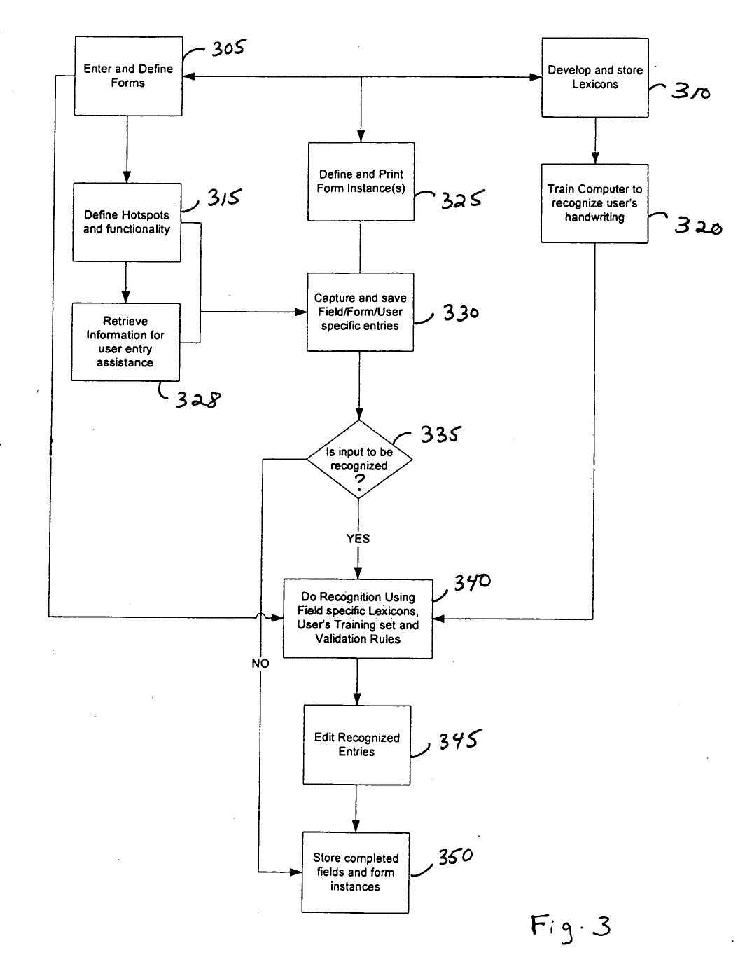

FIG. 3 is a flow chart of the overall operation of an example system according to the present invention. As seen in FIG. 3, the process requires that a set of forms be entered 305 into the system, either via scanning, as electronic copies, or made from scratch electronically. These entered forms, representing the standard forms used in workflows, act as the templates for each form instance that is used. The form templates are then defined by the user through naming the form template, identifying fields within the form template, and capturing the x,y location of the specific fields. The fields may then be further defined by associating a type of entry, such as a mark, handwriting, image, or handwriting that is assigned to be recognized. Field descriptors, e.g., metatags can also be assigned, aiding in later data retrieval (search) and data mining can also be added. The fields that will contain entries that are destined to be recognized may also have an associated lexicon of possible entries. In the current embodiment, the form and field definitions are captured using specialized software that allows rapid user input of form attributes, such as name, as well as field attributes, including x,y location, entry type, and lexicon associations. Furthermore, validation rules may be associated with specific fields, such as the ranges of acceptable entries and exclusion based on other field entries. Additionally, any virtual hotspots associated with specific fields are saved to the database as attributes that are available upon use of any form instance derived from the template. The defined form templates, including the definitions of the fields within each form and the virtual hotspots, are then saved to a database. The templates are then used to generate each specific form instance as needed.

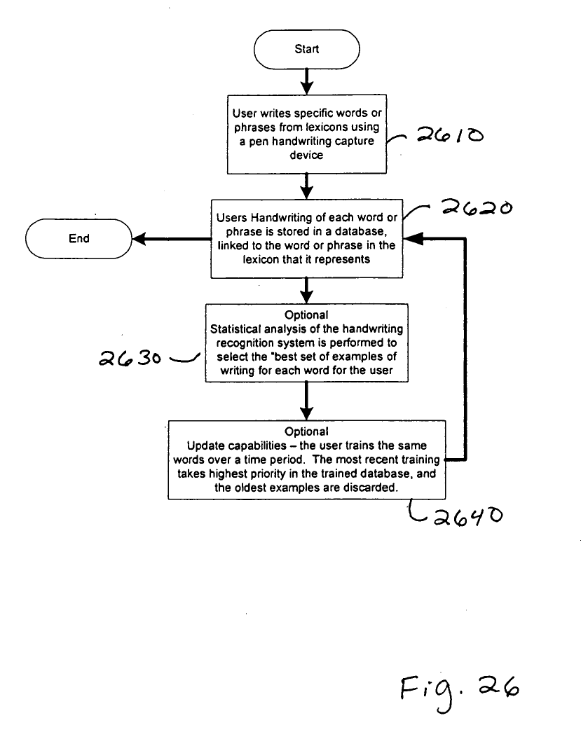

The procedure for developing 310 and storing lexicons is outlined in detail the Develop and store lexicons flowchart shown in FIG. 25. In the current embodiment, domain experts are initially interviewed and provide sets of words and phrases that are grouped into limited lexicons, based on relationships such as topics, as well as known needs for filling out generic forms within a workflow. As each specific form is defined, those limited lexicons provide the basis for building field specific lexicons. Again, domain experts, especially those workers that will be filling out the form instances are interviewed to fully define the form and field specific lexicons. Those form and field specific lexicons are stored in the database with appropriate relationships to the form templates and fields. As form instances are filled out and edited, new words or phrases may be entered into the field specific lexicons, providing for an evolving lexicon base that adequately represents the entries for specific fields.

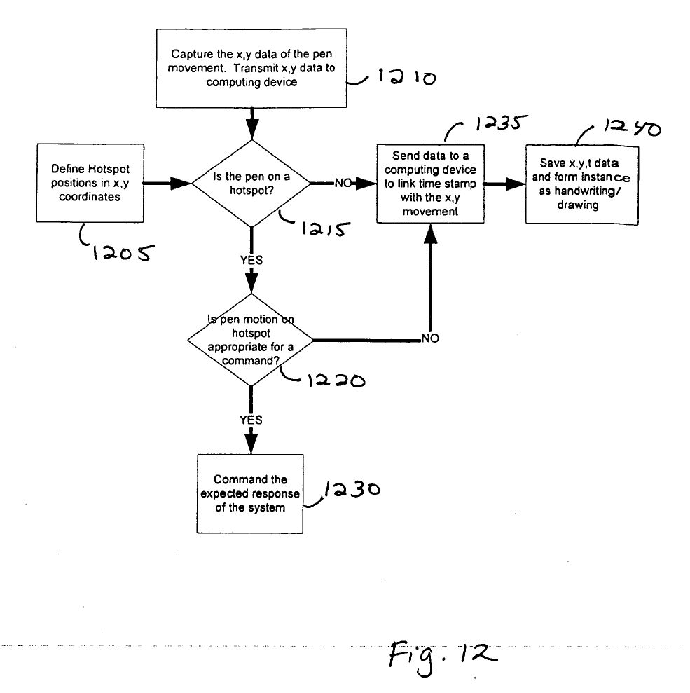

Next, hotspots and functionality are defined 315. A pen-based data entry mechanism is of higher utility and less disruptive to workflows if it can also command and control a computer user interface. Toward that end, the present invention employs the ability to control a computer via pen motion in defined locations. These defined locations, or hotspots, may exist anywhere that the pen detection system can reliably determine pen location and movement, including off the e-clipboard. In the preferred embodiment, the primary hotspots exist on the e-clipboard on the right side for right-handed users and on the left side for left handed users. The pen movement that initiates a computer response is any movement that is identifiable as not handwriting input. Since handwriting location on the e-clipboard may be restricted to that defined by the PaperPlate, and therefore by the form instances, any so defined movement outside the PaperPlate may be used to initiate computer control. In this embodiment, a single pen down movement in a hotspot initiates the associated computer action. Those actions may include, but are not limited to: retrieving a record, showing graphics or other files, initiating web or database access, scrolling through lists, initiating a search, saving the current form instance, starting another program, and exiting the current program. Virtual hotspots may have the same types of associated computer actions, but the virtual hotspots are in regions of the form instance that also accept handwriting input. Hence, pen movement for launching an action from a virtual hotspot requires a very specific pen movement. The procedures for activating a hotspot are shown in detail the HotSpot Command flowchart of FIG. 12.

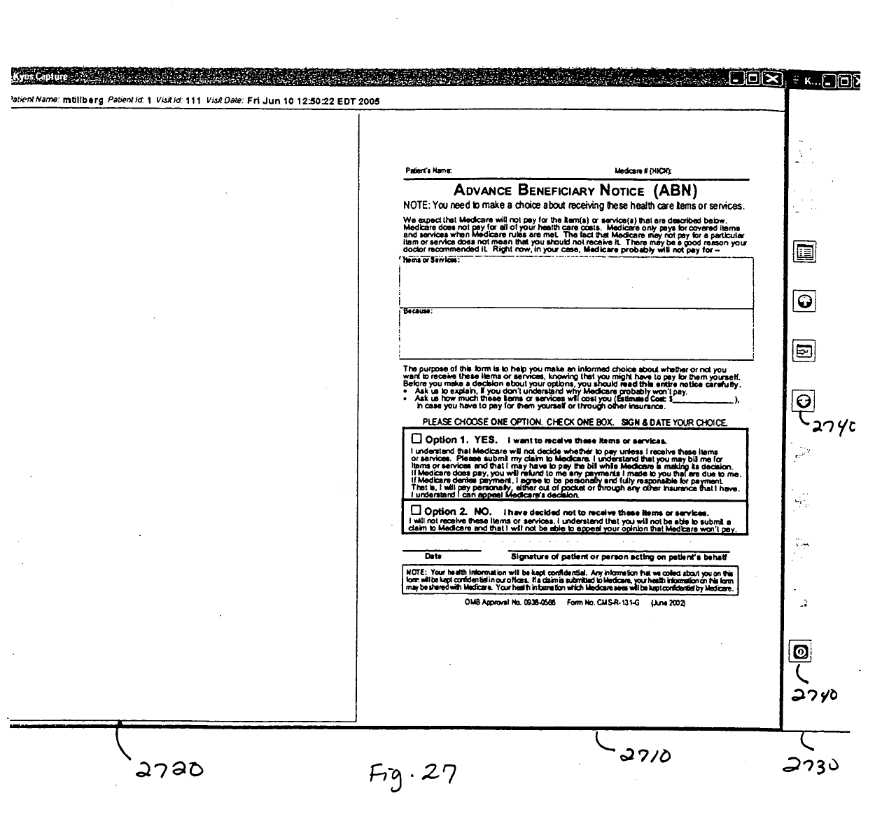

The procedure for training the computer to recognize a user's handwriting 320 is shown in detail the Train Computer flowchart of FIG. 26. The user's entries for each word or phrase is stored in the database as x,y,t coordinates and is linked to a word or phrase in a specific lexicon. In the current embodiment, statistical analysis is performed on the training set of entries in order to identify entries that best represent the user's current style of writing. In addition, as the handwriting of a user may change, new entries, either as training examples or as entries into a form instance, are included as examples to be used for handwriting recognition.

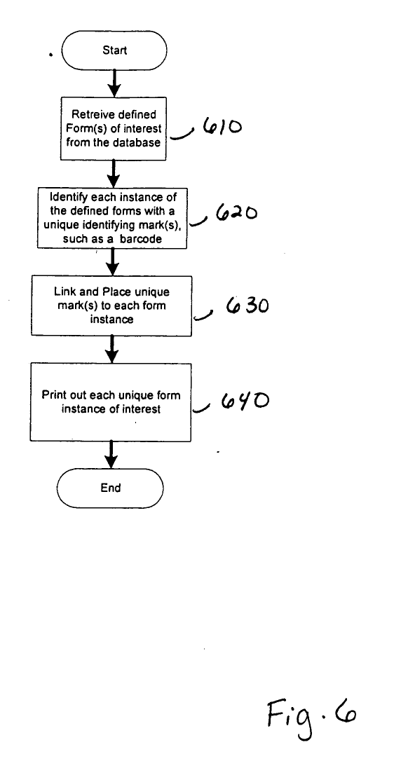

The procedure for defining and printing form instances 325 is shown in detail in the Print form with Identification flow chart of FIG. 6. The system also allows the user to retrieve information 328 for user entry assistance. The use of hotspots enables the recovery of information or data that might inform an entry. For example, a doctor prescribing a drug for a patient might need access to prior visits or records of said patient in order to select appropriate medication due to allergies or other drug-drug interactions. By gaining access to that information through the use of hotspot commands for data, information, and image retrieval, the user is assisted in filling in the form instance.

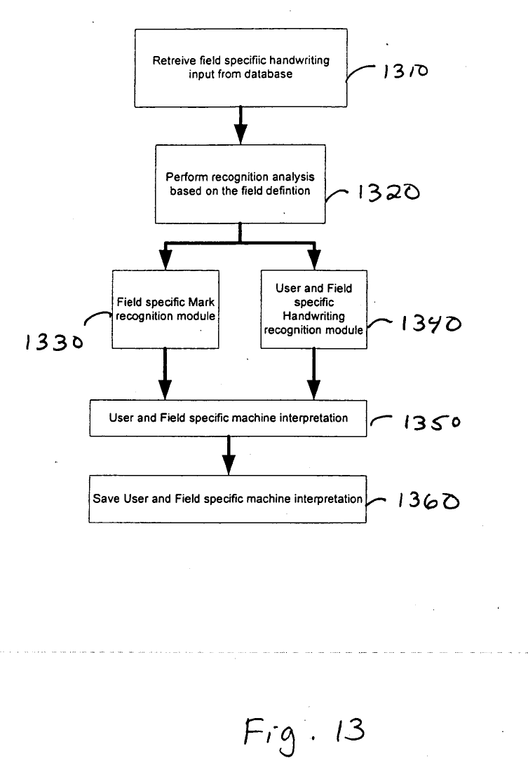

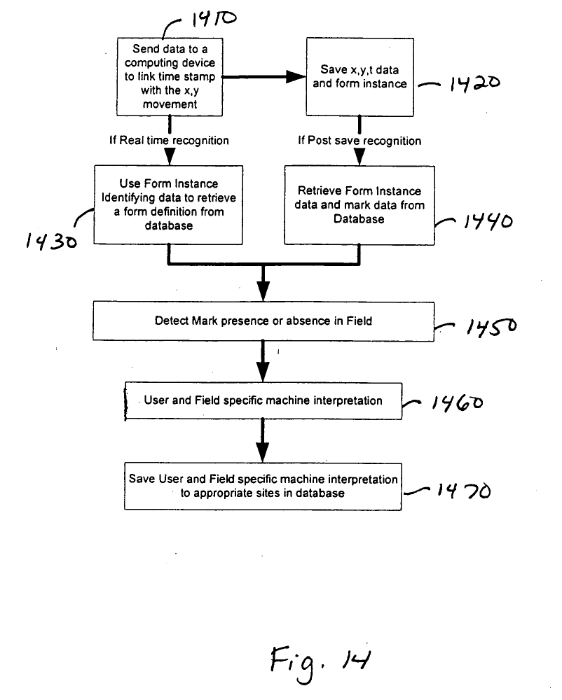

The process for capturing and saving field/form user-specific entries 330 is described in detail in conjunction with FIG. 1. The Form Definition provides the needed information for the decision point on proceeding with recognition 335. The process for doing handwriting and/or mark recognition 340 is described in detail in conjunction with the Field/Form specific recognition flowchart of FIG. 13 and the associated recognition modules of FIGS. 14 and 15.

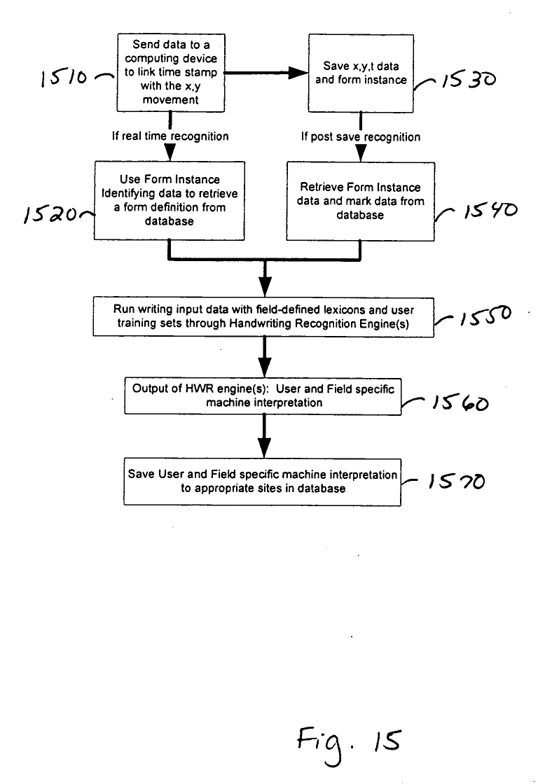

Currently, handwriting recognition and mark recognition is not totally accurate, due to variances in user writing style, inadequate computer training, user mistakes, novel words, inaccurate marking within fields, missed check boxes and user alterations, such as strikethroughs. Because of this, an edit function 345 is necessary and quite useful. The editing process is outlined in detail in conjunction with the Edit machine interpretation flowchart of FIG. 16. As is clear to one of ordinary skill in the art, many approaches may be used to allow the user to identify differences between the handwritten input and the machine interpretation. In the current embodiment, both the original form instance with the pen entries and the form instance with the machine interpretations are shown to a user via a split screen. The fields where the machine interpretation is unavailable or not to a threshold of confidence are initially highlighted, thereby drawing the user's attention immediately to fields that are considered problematic. Furthermore, the user may scan the whole form instance to compare the machine interpretation with the pen input. The user is then able to change the machine interpretation directly or with assistance of a dialog box of suggestions that are words and phrases in the specific lexicon for the field. In addition, the user may add new words or phrases if necessary. In addition to recognition issues, the edit function may include highlighting of entries that are outside the designated rules for a field, such as a value that is outside the specified range or an exclusion based on another entry. Again, the user may change the entry based on the rules. In this embodiment, all changes or edits made to the machine interpreted form instance are logged as to the time, the user, and the location or computer.

The alterations and edited form instances are then saved 350 to the database. In the current embodiment, all pen entries, including handwriting, drawings, and marks and the like are also saved, along with the specific form instance and any attributes such as time of entry, user and location.

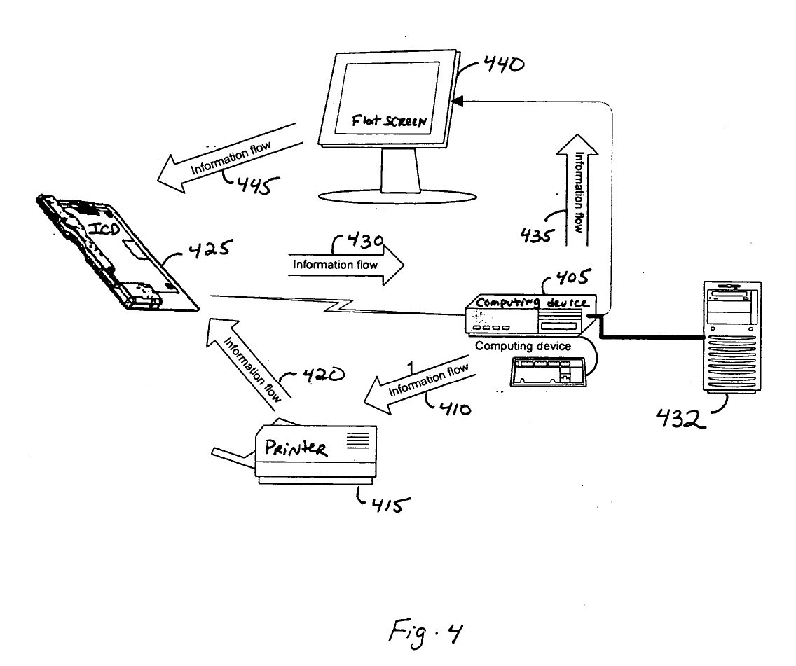

FIG. 4 is a diagram depicting information flow among the components of an embodiment of the present invention. In FIG. 4, forms are generated in computing device 405 using form templates, and specific fields are populated using data resident in the database. The semi-populated forms are then coded with a barcode or other Form Type ID in order to define form type, information, and date/time. These forms are printed 410 at printer 415 and transferred 420 to ICD 425. A user fills in the form fields. The information that is entered also has a date/time stamp for future editing or additional filling out by the same or other users. The field specific information that is filled in is transferred 430 wirelessly to computing device 405 or some other computational or storage device, such as a desktop, laptop or tablet computer, a PDA, or a cell phone. Computing device 405 may include one or more optional servers 432.

Additionally, the pen clipboard device can act as a graphical user interface, in a way similar to the mouse, wherein the user may tap on a specific location or field on the form and begin an application on the computer or hyperlink to other information or sites. Information then provided on the screen of the computing device may be used by the user to make decisions about input into fields of the form. Alternatively, the user may use the pen/e-clipboard to control the screen of the computing device, providing an iterative information cycle. Multiple forms may be accessed and information entered in each one. The barcode specifies to the computer which form is being used, allowing for many combinations of applications, hyperlinks, and fields to be accessed.

A further path of information extends 435 from computing device 405 to screen 440, where the user may visually inspect 445 information coming from computing device 405. In a further embodiment, computational device 405 is then used as a source of data, information, images, and the like by the user. Hence the information is transmitted between the user and the computing device through several cycles. One cycle includes:
(1) User selection of forms and if appropriate, having the computer fill in some fields based on information stored in a database.
(2) The printing of form(s) onto paper, transferring of the paper form(s) to the ICD.
(3) The user filling out form fields (user input).
(4) The user input being captured and transmitted to the computational device by the ICD, with corresponding capture of form specifics, user identification, and time of input.
(5) The computing device storing the input with appropriate tagged information specifying the form, the user and the time for the input.
   The foregoing steps constitute an information capture loop. Further interaction between the user, the ICD, and the computing device may include:
(6) Display of form, form instance and other information on a screen visible to the user allows real-time adjustment of the user input and comparison with other data. This process depends upon the information flow that may be a display of the form instance currently being used, as well as retrieval of other documents, including forms, form instances, documents, defined queries from databases, web pages, and the like. In order to access these other information sources, the IDC may be used in place of a mouse or other controlling device for the computing device. In this manner, some manipulation of the WI on the specific form, such as the tapping, writing or holding down of the WI in defined locations on said form result in predetermined functions (hyperlinking, starting or controlling other applications, and the like) by the computing device. Since each form, document or drawing shown on the paper is identified via the barcode or other means by the IDC, a completely customizable interaction with the computing device, specified by each form or document and even system defined user access is possible. Furthermore, if the computing device is networked to servers or other computing devices, then the user may have access to other manifestations of information residing within the network or the internet.
(7) By showing the information, documents, or applications on the screen, the user then is able to access and use the information gathered by the computing device in decision processes to modify, amend, or enhance his or her input. In this manner, the IDC system not only allows easy and rapid input of any form of writing and drawing, but also a mechanism to fully utilize information storage, retrieval and computing capability of the computing device.

The process allows one or multiple users to access a common data storage and computing system via wired or wireless means through interaction with a very natural, comfortable, convenient, and familiar modality, namely by writing, drawing or painting on paper or other surfaces. The computing device may also act as receiver for input from other devices, such as digital cameras, microphones, medical instruments, test equipment, and the like, for transmission of pictures, voice and data. The security and integrity of the data accessed and transmitted is defined by the hardware or by specific software that renders the IDC useless outside of a specified range.

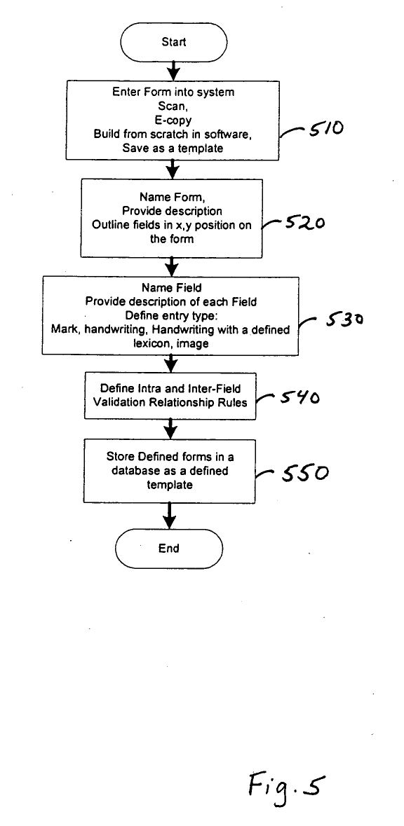

FIG. 5 is a flow chart of the process of entering and defining a new form according to one aspect of an embodiment of the present invention. In FIG. 5, paper forms are entered 510 into the database electronically, scanned in to make electronic copies, or designed and built using software. These electronic forms are then used as templates for entering data. The electronic forms are named and described 520 as a series of entry fields and existing printed areas that are not used for data entry, but rather guide the user as to what should be entered. The entry fields within the form are named and described 530 such that the locations in the x,y plane of the form are determined. The fields are also defined 540 as to what type of input is necessary for the field, such as a mark (check or “x”), writing, writing that is to be recognized, drawings or other image types. In addition, depending upon the nature of the field, lexicons or allowable entries may be associated with the writing input for the field. Once the form has been defined, it is stored 550 with the associated information about fields within the form into the database. The defined form can then be used multiple times as the template for each form instance. Each form instance is a unique copy of the form that may then be used for data entry. Each unique form instance may be assigned a unique identifier, such as a unique barcode. In this manner, each form instance and the corresponding data entered in the form instance may be stored, filled out and tracked.

The user may begin by entering forms into the system via scanning, directly opening electronic forms, or developing the forms using standard word or form processing software, such as Microsoft Word, Open Office, Microsoft Infopath, and the like. The form type may be any format or a MIME type that can be used directly in the system or can be converted. The current embodiment recognizes PDF, PNG and BMP MIME types. Standard software packages may be used to convert from other MIME types, such as jpeg, tiff and GIF. Once entered into the system, the files containing the images of the forms are saved to be used as templates for form instances. After the forms are captured, a process referred to as form defining or definition allows the user to attach attributes to the form template. These attributes include, but are not limited to, a name of the form template, a description of the form template, and any specific rules for the use of the form template, such as a restriction on the users that may have access or input data on a resulting form instance. In addition, the locations on the form template where input occurs are defined as fields. These fields are defined initially by their x,y location on the form template. Further attributes may be associated with the specific fields, such as the name of the field, a description of the field, instructions for the entries for the field, the type of entry, such as, but not limited to, a mark, handwriting, images, drawings, words, phrases or alpha-numeric and machine text.

Further definition of both the form and the fields may be as validation and relationship rules for allowable entries. These rules may include, but are not limited to, exclusion, such as if one box is checked, then another box must be checked or should be blank. Another example of exclusion includes dependant input based on specific entries of a lexicon. Other rules include the placing of limits for entries for a single field. These validation rules may be limited to the form template, or may extend across several form templates. The defined form templates are then stored in the database and used to instantiate form instances when needed.

FIG. 6 is a flow chart of the process of printing out a defined form with an identifier according to one aspect of an embodiment of the present invention. The capture of input data using forms and a writing implement may in some cases require the identification of the form instance upon which the user is writing. Hence, the form instance has some means of identification, such as an identifying set of marks, a tag or a barcode. In FIG. 6, the form of interest is retrieved 610 from the database and the identifying mark, such as a barcode, is assigned 620 to the form instance, preferably by placing it in the defined form so that it will be printed directly on the form. In this manner, a detecting device, such as, but not limited to, a camera, a barcode reader, or an RFID reader is able to capture the information contained in the identifier while the pen is being used to write on the form instance. In the preferred embodiment, a unique number that is translated into the corresponding barcode is provided for each form instance. In this manner, the printed form instance contains both the form template and the unique identifying barcode that links 630 the specific form instance with its corresponding electronic copy in the database. The user may then print 640 each type of form needed for a particular workflow.

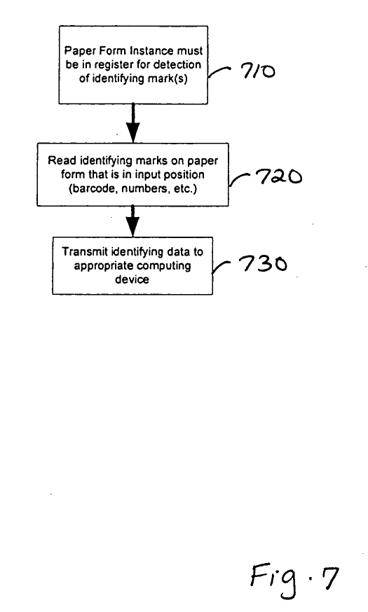

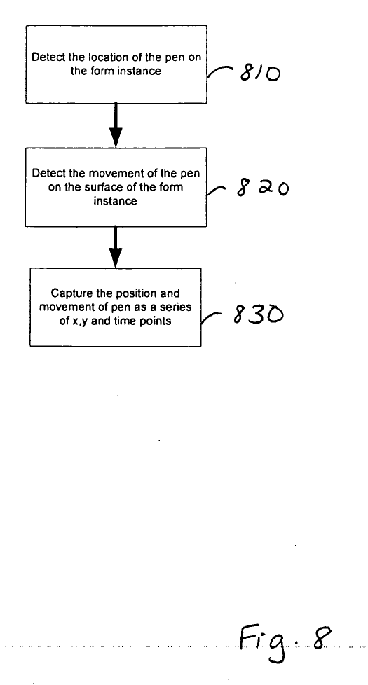

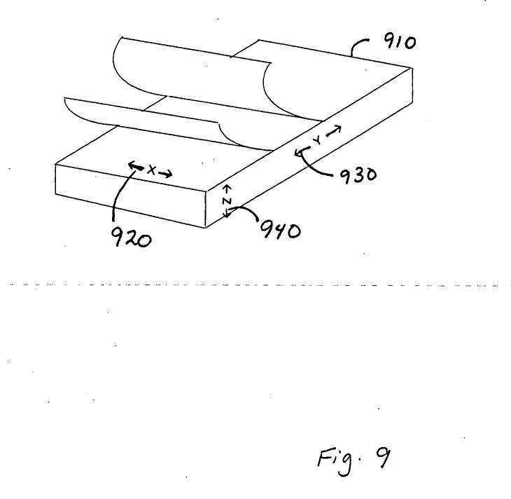

FIG. 7 is a flow chart of the process of detecting which form type is being currently used according to one aspect of an embodiment of the present invention. In FIG. 7, a form instance detection process 710 is required to allow the system to coordinate pen input with a specific form instance. This may be accomplished in a number of ways, dependant upon the identifying system. Capturing 720 of the identifiers allows linking the timing of the pen input and the specific form identification. In the current embodiment, a barcode reader (Symbol Technologies SE 923 scan engine) captures the barcode and decodes the data. The identifier data is then transmitted 730 to the computing device. The identifier as attached to the paper form instance must be located in a position on the form instance such that the reading device is able to capture the identifier quickly. In the current embodiment, the barcode is located at the lower left of the form (for right handed users), allowing the barcode reader within its assembly to rapidly scan the barcode and capture the data.

FIG. 8 represents the flow chart of the process of detecting pen writing/drawing strokes according to one aspect of an embodiment of the present invention. In FIG. 8, the location of the pen on the form instance is detected 810. Next, the movement of the pen on the surface of the form instance is detected 820. Finally the position and movement of the pen are captured 830 as a series of x,y, and time points.

Pen stroke motion during contact with the paper form instance is captured in a number of ways. For example, many commercial systems exist that allow pen stroke data to be captured, including the Logitech Digital Pen or the Pegasus PC Notetaker or WACOM or AceCad magnetic induction devices. These devices rely on differing technologies to capture the position of the pen over time, the Logitech Digital Pen using a special paper and camera within the pen body to detect position, the Pegasus PC Notetaker uses x,y triangulation of ultrasound beams to detect position. In any of these devices, the x,y location of the pen device is coupled to time by sampling position at a constant frequency. In the current embodiment, pen position is determined using ultrasound triangulation at a constant frequency, between 60 and 100 Hz. The positional data is captured and communicated to the computing device for manipulation. Because the detector is situated on the left side of the e-clipboard (for right handed users), and the algorithms employed by the pen capture software is designed to have the pen detector located at the top of the page, the data is transformed to register with the directionality of the form instance.

FIG. 9 depicts example paper stack 910 showing the x- 920, y- 930, and z- 940 axes utilized by the process of FIG. 8. This figure illustrates the 3 dimensions used in the pen location detection process. As can be seen in FIG. 9, z-axis 930 is the direction normal to the plan of the paper stack, and x 920 and y 930 represent the surface dimensions of the paper.

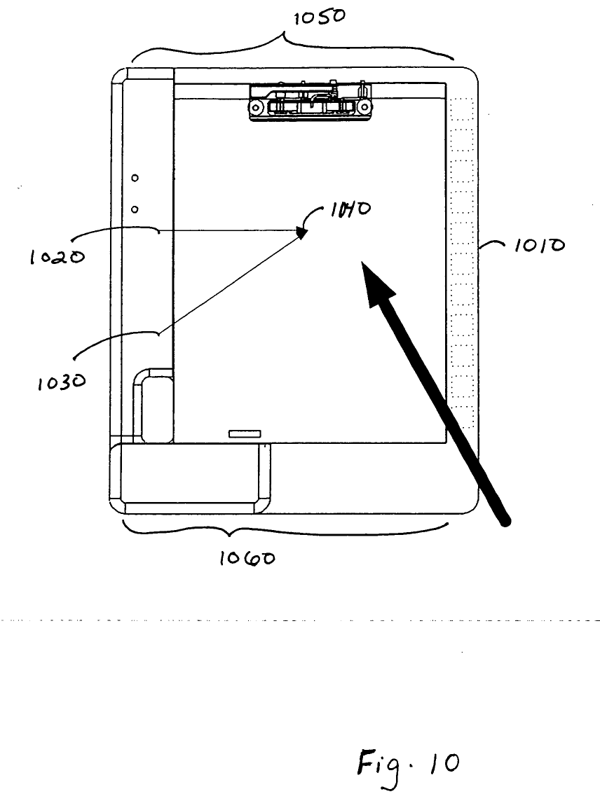

FIG. 10 is an example showing x,y triangulation according to the process of FIG. 8. In FIG. 10, the complete e-clipboard 1010 of the preferred embodiment of the ICD is shown as designed for a user that writes with his/her right hand. In this embodiment, the position of the arm and hand is such that the pen device is always “visible” to pen detectors 1020, 1030, thereby allowing appropriate triangulation to determine exact pen position 1140. If the pen detectors were located at the top 1050 or bottom 1060 of e-clipboard 1010, certain positions of the hand and arm might block the ability of the detectors to locate the pen position. Other, more complicated embodiments may have multiple pen detectors and computational algorithms that determine pen position using a subset of the detectors depending upon their signals.

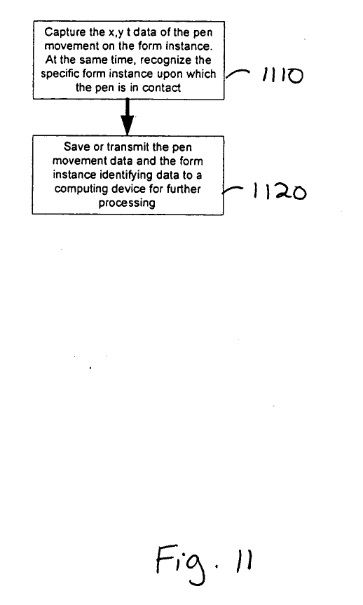

FIG. 11 is flow chart of the process of capture and transmission or storage of writing or drawing on a form according to one aspect of an embodiment of the present invention. In FIG. 11, during or after the capturing 1110 of pen stroke and form instance identification data, the data is transmitted 1120 to a computing device within the e-clipboard that then packages the data for transmission to either another computing device or a device for saving. In the current embodiment, an Intel 8051 chip acts as the communication device for packaging and decisions about data transmission. The data, including both the pen movement data and the barcode form instance identifying data, is sent in the current embodiment via wireless means (900 MHz radio—Radiotronix wi232) from the e-clipboard to the host computer radio.

The captured data may be transmitted from the ICD to the host computing device by any means known in the art, including, but not limited to direct wired, optical, or wireless communications. Wireless communication, where a central transceiver provides wireless access and transmission of data using a radio frequency link and a wireless protocol, such as, but not limited to, Bluetooth, 802.11(WiFi) and Home Rf MHz), allows two-way communication between the transceiver and a remote device and is particularly advantageous in the present invention because of the flexibility of movement it provides to the user. The utility of the pen-based system for workflow is in part related to the ability of the user to interact with a computing device without the need for a keyboard or mouse. This is particularly important in workflows where the keyboard or mouse presents a physical or psychological disruption to the workflow. An example of where a keyboard and mouse may be disruptive to workflow might be the patient interview process by a physician or healthcare worker. The physical necessity of using a keyboard results in the doctor's attention being directed to the keyboard and the data entry, whereas a pen based entry system is much more facile and familiar. Furthermore, the patient does not feel “abandoned” by the doctor during data entry. In addition, in workflows and use cases where drawings and drawing annotations are part of the workflow, e.g., ophthalmology, orthopedics, insurance claim forms, accident report forms, and the like, where object relationships are required to be depicted, this pen based workflow is superior to mouse and keyboard approaches.

In order for the pen-based system to facilitate the interaction between the computing device and the user, a means for controlling the computing device is required. The control of the computing device may be accomplished through a pen based system in several ways, including, but not restricted to, identifying regions where the location of the pen device is detectable and using movement in those regions to command the computing device, touchpad control, voice activation and the like. In the current embodiment, the movement and location of the pen controls the computing device.

FIG. 12 is a flow chart of the processing of hotspot commands generated by pen position according to one aspect of an embodiment of the present invention. As shown in FIG. 12, initially the x,y coordinates of the hotspots related to each form template are defined 1205. These may include locations on the form template itself, referred to as “virtual hotspots”, as the x,y coordinates may or may not have the same effect on different form templates, and locations outside of the form template, but still within the range of detection for pen movement. In addition, the pen movement required for computer control is defined, for example, a single tap or a sweep of the pen in a hotspot location. Finally, the function resulting from the pen movement within a hotspot or virtual hotspot is defined. These functions may be, but are not limited to, saving of the form instance, returning another form instance, erasing of strokes, opening another application, closing another application, retrieving data, navigating to the world wide web and retrieving and opening files.

FIG. 12 depicts the decision points for the determination of launching of a hotspot command. The pen location is tracked 1210, and if it enters a hotspot 1215, the system monitors the movement. If the movement and the location of the pen are correct for a specific command 1220, the command is launched 1230, otherwise, if the hotspot is on the form instance itself, the movement is interpreted as a pen stroke and handled by sending data to the computing device 1235 for saving 1240 and other processing in preparation for handwriting recognition.

FIG. 13 is a flow chart of the general process of field- and form-specific recognition according to one aspect of an embodiment of the present invention. The approaches to apply recognition engines to the handwritten or drawn input are varied. Through the use of field definitions, one may apply recognition that is appropriate to the field type. In that manner, the recognition engines may be restricted by the field input type to handwriting, mark recognition, character recognition, pattern recognition and or other types of input. In the current embodiment, the type of recognition that is applied to a field is dictated by the field input type, i.e. handwriting recognition or mark recognition, although other types of recognition may be applied. In addition, some recognition engines are designed to function in real time with the writing input, while others, including the current embodiment function, perform the recognition after part or all of the specific form instance is filled in. This allows a greater use of validation rules during the recognition process.

In the current embodiment, the recognition process initiates with retrieval 1310 of the specific field input, as well as the type of input as defined by the form definition. In the case of a field with mark input, the recognition analysis is performed 1320 based on the field definition through the Field specific Mark Recognition module 1330. In the case of a field with handwriting input designated for recognition, the recognition 1320 is accomplished using the user and field specific handwriting recognition module 1340. The output of these modules is machine interpreted text or marks 1350 that may be represented as Boolean true/false values, or the like. Those machine interpreted texts or values are then saved 1360 to the database, linked to the specific field and form instance.

FIG. 14 is a flow chart of the process of field-specific mark recognition according to one aspect of an embodiment of the present invention. The computational recognition of a mark in a specified field may occur in a number of ways, including, but not limited to, the counting of input pixels in a specific area or the detection of a pen stroke within a specified field. The recognition may also occur in real time, as soon as the mark is written, or may occur after the form instance or field is saved. In the current embodiment, the marks are recognized after a complete or partially completed form is saved to the database. This allows a more extensive use of validation rules than might be possible is the marks were detected in real time. However, it is anticipated that a combination of the two approaches will be used in the future.

In FIG. 14, the detection of the mark in the field in this embodiment is accomplished by noting the existence of a pen stroke having the x,y coordinates within the field. In general, to limit the false positives for the field, a minimum number of pen stroke x,y points are required to be within the field on the form instance. The data is sent 1410 to the computing device to link the time stamp with the x,y movement. The x,y,t data and form instance 1420 are saved for processing. Form instance identifying data is used to retrieve 1430 a form definition from the database and the form instance data and mark data 1440 are then also retrieved 1440. Next, the presence or absence of a mark in the field is detected 1450, allowing user and field specific machine interpretation 1460. The existence of the pen x,y data points fitting the criteria for a mark results in a Boolean value of true for the field. The machine interpretation data is then saved 1470 to the database, linked to the field and form instance.

FIG. 15 is a flow chart of the process of user- and field-specific handwriting recognition according to one aspect of an embodiment of the present invention. In FIG. 15, pen position via x,y, and t (time) coordinates are sent 1510 to a computing device. The computing device then saves 1530 the x,y,t data gathered for that particular form instance. The computing device uses barcode data resident on the form instance or other form identifying characteristics to retrieve 1520 a form definition from the database. This form definition identifies precisely what specific form is being used in conjunction with the ink data gathered. If saved, the form instance and mark data are also retrieved 1540 from the database.

In the case of real time recognition, sometimes referred to as online recognition, the x,y, and t data is directly fed to recognition processing 1550 that reconstructs and interprets, i.e., recognizes, the handwritten input. In the case of post save recognition, handwriting input is stored 1530 for later feed into recognition processing. Processed handwritten input is then interpreted 1560 by using a score relative to samples within the database for best match fit. Identifying the best match fit to handwriting samples in the database identifies the machine text version of that handwriting sample, the output of which is placed within the corresponding fields to generate a recognized form instance. Both the field specific native input electronic and the corresponding recognized fields are saved 1570 to appropriate sites in the database. Retrieval of either the input form or the recognized form from the database regenerates the input form with handwritten entries or the machine text recognized version of that form for display.

The handwriting analysis function of the present invention can be implemented using any of the many algorithms known in the art. The currently preferred embodiment largely relies on the algorithm set forth in “On-Line Handwriting Recognition Using Physics-based Shape Metamorphosis”, Pavlidis et al, Pattern Recognition 31; 1589-1600 (1998), and Recognition of on-line Handwritten Patterns Through Shape Metamorphosis, Proceedings of the 13^{th} International Conference on Pattern Recognition 3; 18-22 (1996). Another suitable algorithm is set forth in “Normalization Ensemble for Handwritten Character Recognition”, Liu et al IEEE Computer Society, Proceedings of the 9^{th} International Workshop on Frontiers in Handwriting Recognition, 2004, Many other algorithms, variations, and optimizations are suitable and may be advantageously employed in the present invention, alone or in combination.

FIG. 16 is a flow chart of the process of editing machine interpretations of entries according to one aspect of an embodiment of the present invention. In FIG. 16, the authorized user identifies 1610 the specific forms he/she is interested in reviewing and if necessary, editing. The server houses the native (electronic) input form with handwriting along with the machine text converted and recognized form. The native and recognized cognate forms are linked in the system and are simultaneously retrieved 1620, 1630 and displayed 1640 for viewing via split screen, with the native input form on one side and the recognized form on the other or, alternatively, one on top and one on the bottom. Other ways of viewing and comparing may also be used, depending on user preference.

The current embodiment allows the user to move from form to form and from field to field within matching forms, reviewing and, if necessary, editing 1650 as needed. User alterations are done typically by typing any required changes via keyboard within the correct field in the recognized form. Once changes have been made to the recognized form, the user can then accept and save these edited changes. The system captures 1660 the alterations. The preferred embodiment will track versioning. Security measures such as user id, password, and the like can be required in order to provide added security to data integrity. Further measures such as machine stamping and digital signatures can be layered in for additional security and audit capabilities. The alterations, when saved 1670, are directly entered into the database along with relevant security information and versioning documentation. The system allows read only access to authorized users for longitudinal (time-based) and horizontal (field-based) data mining.

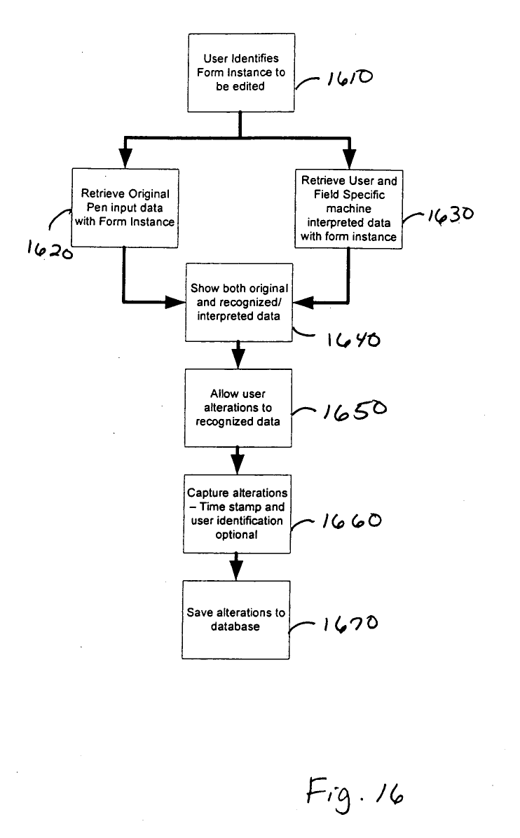

The preferred embodiment of the ICD comprises the following: a writing, drawing, or painting surface, a writing, drawing, or painting implement, a writing, drawing, or painting implement location and detection system, a form identification system, and a means to transmit data to a computing device about the location on the surface of the writing, drawing, or painting implement and the form identification. FIG. 17 depicts an example implementation of an Input and Control Device according to one aspect of the present invention.

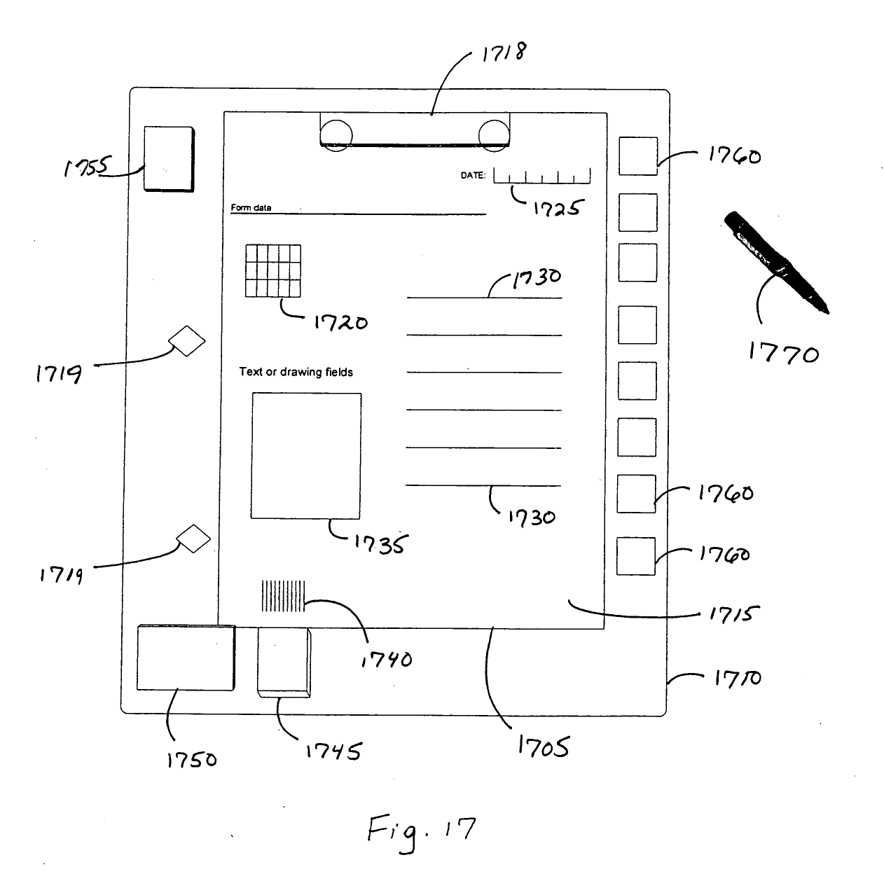

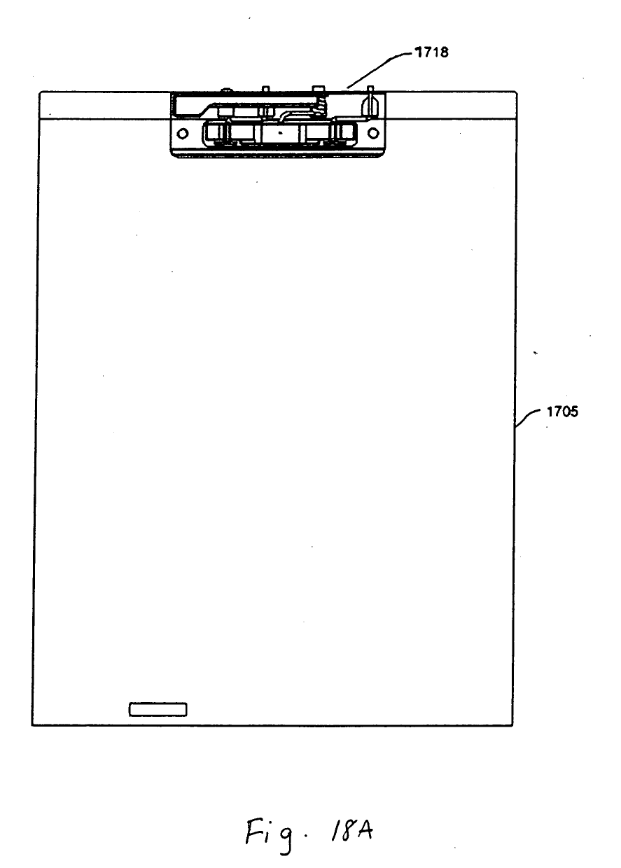

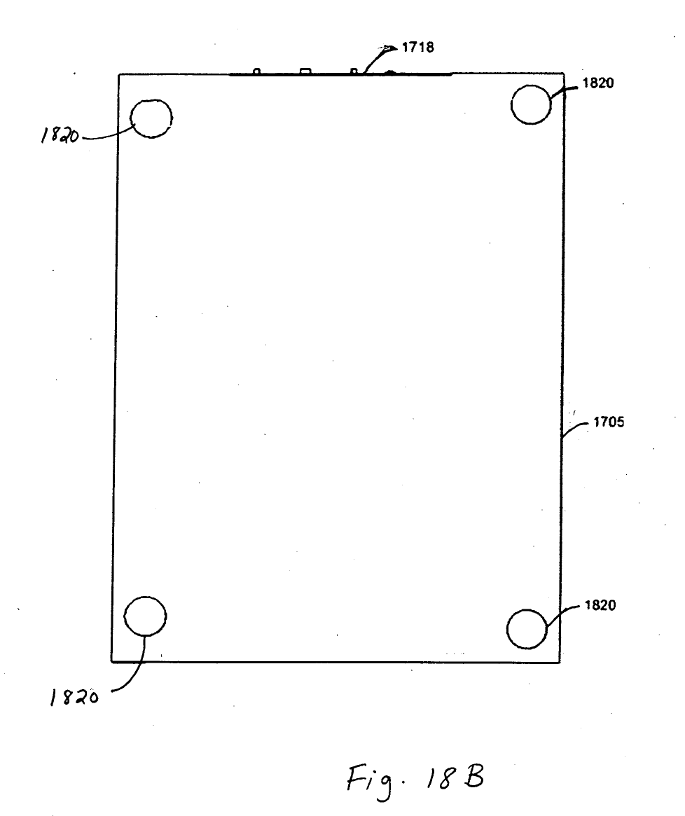

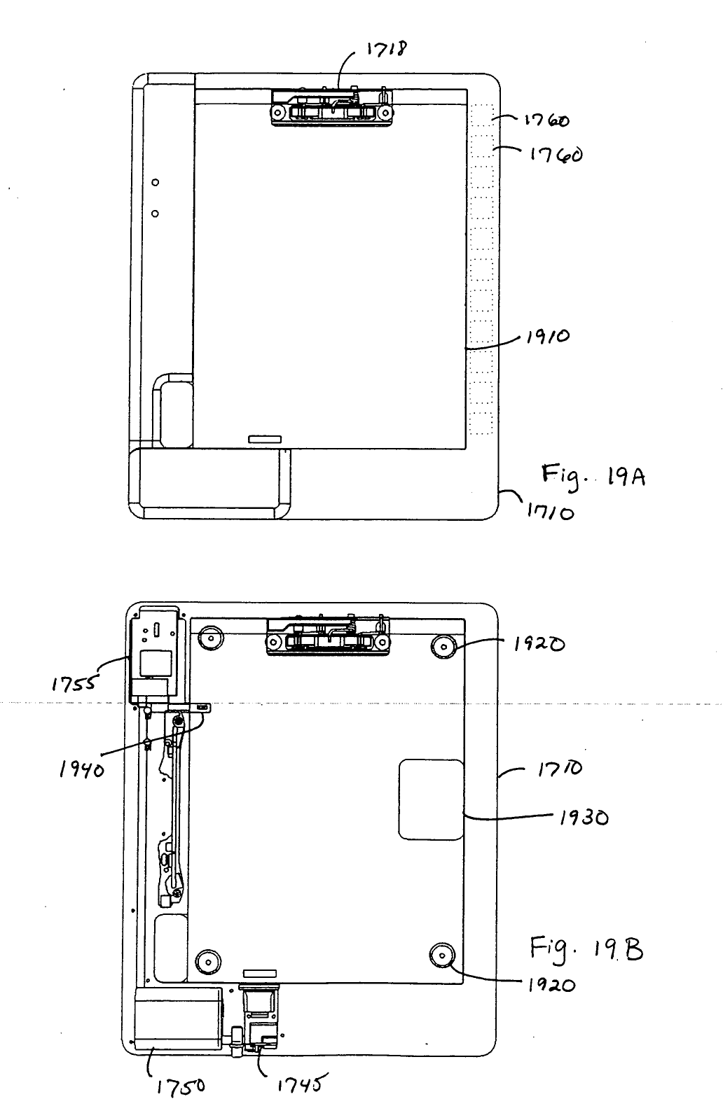

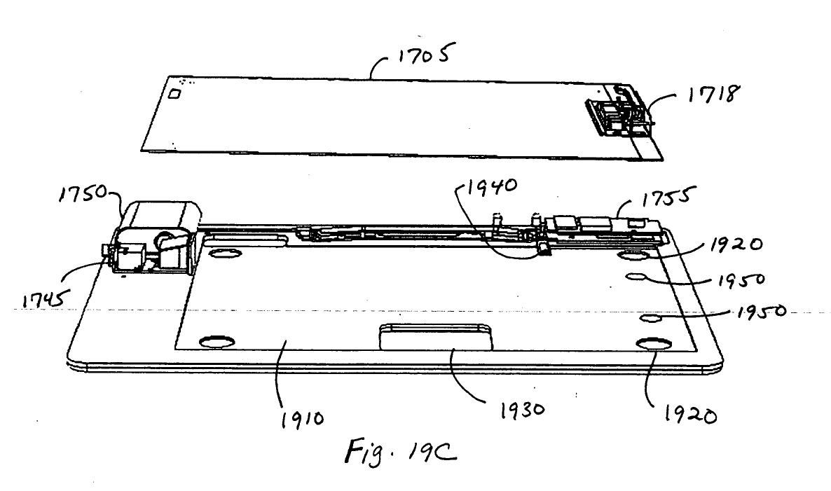

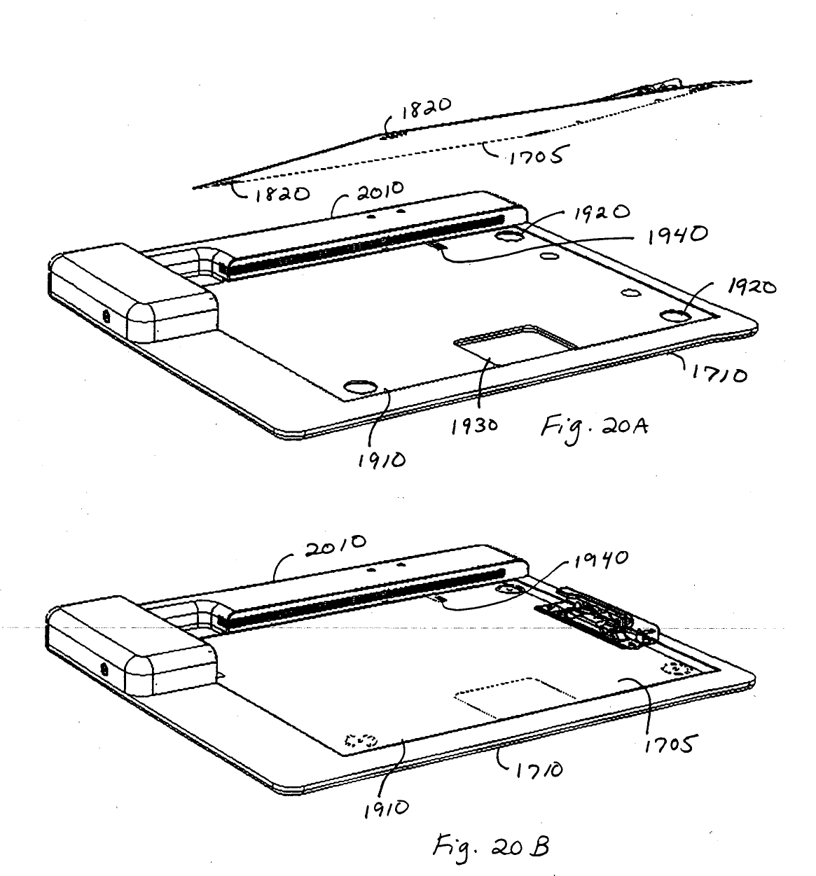

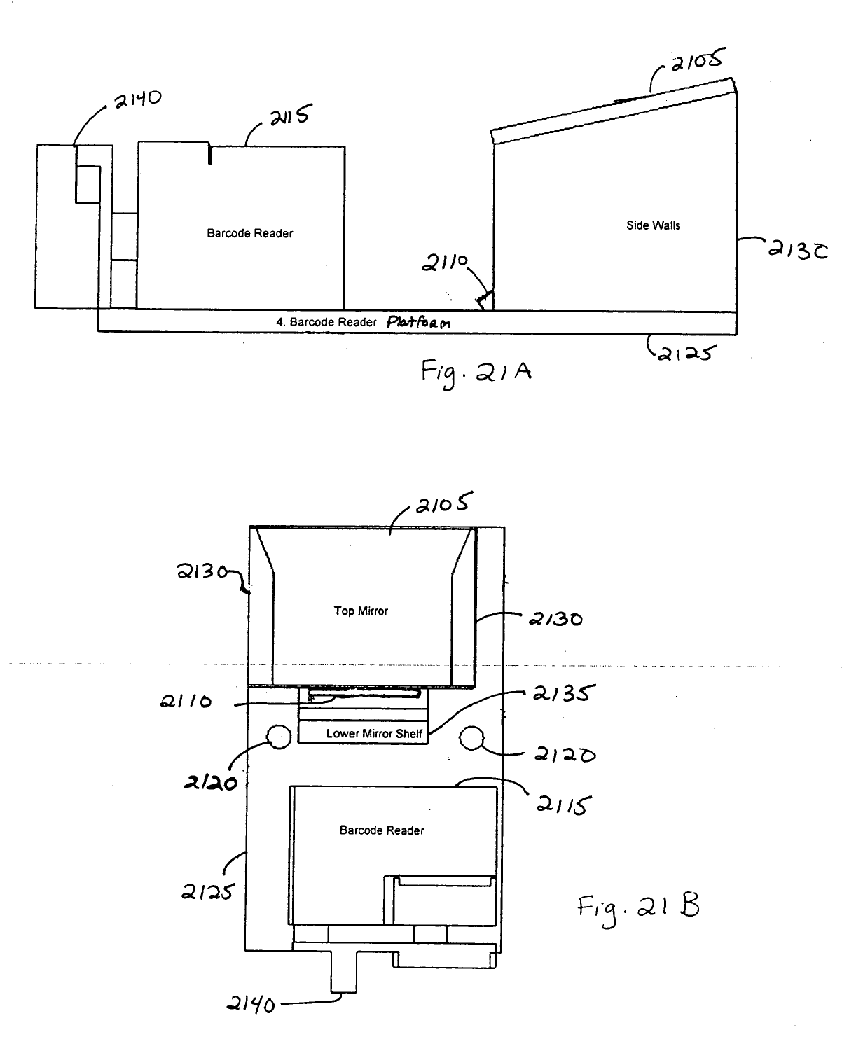

In FIG. 17, PaperPlate 1705, a component that holds pages of paper in a constant position, is designed to dock into e-clipboard 1710 so that PaperPlate 1705 is held in a constant and verifiable position relative to e-clipboard 1710. Hence, when PaperPlate 1705 is in place on e-clipboard 1710, form instance 1715 held by paper locking device 1718 of PaperPlate 1705 is in an identifiable and constant position relative to e-clipboard 1710. PaperPlate 1705 is shown in more detail in FIGS. 18A and 18B. e-clipboard 1710 is the component that contains the electronics that captures the writing and drawing data and the page identity as well as transmits the data (wired or wireless) to the host computing device. e-clipboard 1710 has a well, an exactly-sized depression for holding PaperPlate 1705, and therefore each form instance 1715 on the PaperPlate, securely and in the same location relative to the pen data capture system 1719. The e-clipboard is shown in more detail in FIGS. 19A-C, and insertion of the PaperPlate onto the e-clipboard is depicted in FIGS. 20A and 20B.

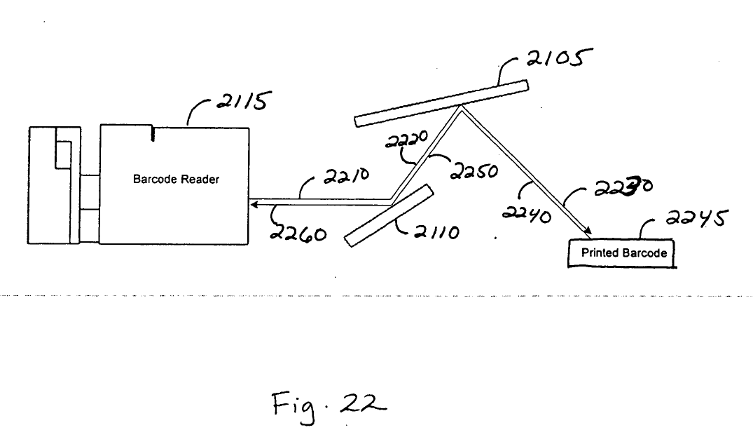

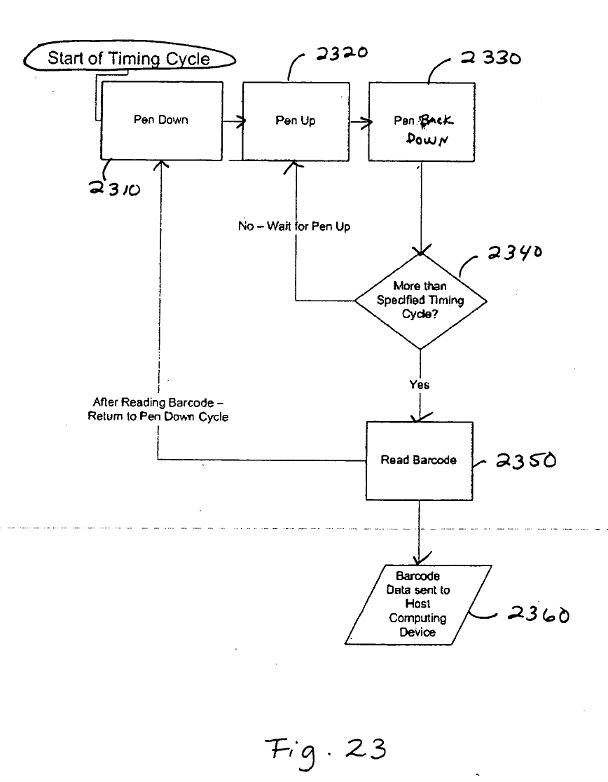

Form instance 1715 has several possible fields, such as table 1720, date field 1725, open fields 1730, drawing field 1735, and may optionally also have specific fields that might require a limited input, such as a lexicon limited field and/or fields that require specific ranges, such as numerical ranges. They might also have specific fields comprised of check boxes to indicate binary conditions as yes/no, or normal/abnormal. Examples of range-limited fields might be, for example, fields that contain blood pressure, temperature, weight, monetary, time measurements or other quantities. Barcode 1740 is shown in the lower left area of the form instance. In this embodiment, the barcode contains the identifying information that specifies the specific form instance. Its placement is important in that reading device 1745, in this case a barcode reader such as the Symbol SE-923, is located unobtrusively on the lower left of e-clipboard 1710. In this embodiment, barcode reader 1745 is mounted in e-clipboard 1710 such that it is able to quickly read the barcodes in a specific place on the paper sheets or forms. An example of a bar code reader useful in the present invention is shown in more detail in FIGS. 21A, 21B, and 22.

In cases where e-clipboard 1710 is not attached to an external power supply, such as a USB cable or transformer, power is derived from a battery source. In this embodiment, battery 1750 is located in the lower left corner of e-clipboard 1710. Battery 1750 provides electricity for the components of e-clipboard 1710, such as barcode reader 1745, the pen detection system, any on board computing components (in this case, Intel 8051s), radios and other communication devices 1755, and any lights or other components that may be on e-clipboard 1710.

Hotspots 1760 are locations on e-clipboard 1710 that, upon tapping or other movement with the pen or other writing implement (WI) 1770, produce a computer action, such as, for example, saving a file, opening a file, moving through a list, closing a program, initiating a program, providing portal and internet access, capturing data, and minimizing or maximizing part of the screen. Virtual hotspots are positions on the form instance that, upon appropriate pen movement, such as two rapid taps in succession, cause a command to be followed by the computing device. These virtual hotspots and the commands that are issued may be located anywhere on the form instance and may or may not be specific to the form instance. For example, tapping upon a typed area of the form instance might bring up a dialog box on the screen that provides information about what should be filled out in the form next to the typed area. Other computer actions may be incorporated through a series of hotspot interactions, such as identification of the user. In one embodiment, the user may tap on specific hotspots in sequence to enter a code or “hotspot password”.

The present invention utilizes a writing, drawing, or painting implement (WI) that is recognizable by the location and detection system. The WI's location and contact information with the ICD must be capturable. The set of information comprising the WI location, the WI contact time with the surface, the form type, and the form instance is referred to as the “WI and form data”. The WI may be an ordinary writing implement if the ICD is configured to capture pen movement through some means such as, but not limited to, pressure, RFID, magnetic transduction off a flat surface, a reflective surface on the pen coupled with an infrared reader, and/or other optical detection means, or it may be a specialized electronic writing implement that actively communicates with the ICD and/or the host computing device. Examples of such devices include, but are not limited to, the Seiko or Pegasus pens, which both employ ultrasound for the detection of pen position.

At a minimum, the host computing device is any device that is capable of receiving and storing information from the ICD. The computing device may also be used to access, store, and utilize other files, such as documents, graphics, and tables, to run other applications, such as standard document processing, spreadsheet, database, presentation, and communication applications, to interact with other computers and the like through an intranet or the internet, to capture, store, and use information, documents, or graphics from other input devices, etc. Therefore, the computing device may be a commercially available product, such as, but not limited to PDAs, advanced cell phones, laptop, tablet and desktop computers, and the like. The computing device may also be a thin or ultra-thin client device that routes information, data, and instructions directly to other computers and computing devices, such as servers and mainframe computers on a network. Multiple ICD systems may transmit data, information, and instructions to one or to multiple computing devices.

At a minimum, the system of the present invention (ICD, WI, and the host computing device) has the following capabilities:
1. Ability to record and transmit to the computing device the location and contacting of the WI on the paper or surface by the ICD. In addition, the computing device capability includes the ability to interpret and store the data in terms of WI location and movement.
2. The ability by the ICD to identify the paper form or surface upon which the WI is in contact in real time. Preferably, this requirement extends to specific pages within a “stack” of paper or forms. In addition, the process must be able to link the surface information to the writing, drawing, or painting positional data. Hence, the ICD must not only capture the motion of the writing implement, but also identify upon which form or piece of paper in a stack of papers the writing is occurring.

Features found in some embodiments may include wired or wireless transmission of the WI and form data to the computing device, correlation of the WI and form data with a user identification process, such that the user is known and linked to his or her specific input, correlation of the WI and form data with date and time, such that the input time for specific data is known, output of the computing device to a screen such that the user might monitor his/her interactions with computing device or to have the ability to see a form instance being filled in, interactive control of the computing device, such that tapping or specific movements of the writing implement causes the computing device to actively do something, such as open another document, launch an application, make corrections in a documents, initiate character recognition, etc., interactive control of the computing device based on WI and form data, rapid and facile changing of stacks of forms to accommodate workflow needs, such as different patients in a Doctor's office, different clients in a business or legal firm, or different sections of a warehouse during inventory assessment, and/or rapid and facile changing of forms or pages within a stack to accommodate workflow needs, such as addition of a form based on the patient's interview.

A number of specific components are described herein as being part of the implementation of the preferred embodiment of the present invention. The components together make up the ICD and the system that allows the direct capture of the user's handwriting on multiple forms in a workflow centric manner. In describing these components, the following terms are used:

Form Type—The type of form that is being used or filled out. This may be a single copy of the form, or many copies, each of which then becomes a form instance upon filling out or utilizing.

Form Instance—the specific page of a form that is being filled in or has been filled in by the user or the computing device.

Locations in 3 dimensions of space—the location in space is described as the plane of the an object—for example, the sheets of paper, or the plane of the board as being the x,y plane. Any location above or below the plane of the sheets of the paper is described as the z position.

Stack—the assemblage of a set of papers or forms in a neat pile, such that the x and y location of each page within the stack is the same.

Pen up, Pen down—Pen up is when the user is not using the pen to write upon the paper. Pen down is when the user is writing or drawing on the paper or activating hotspots.

The e-clipboard constitutes the portion of the ICD that supports the electronics and power supply required for capturing the writing and drawing, as well as the data transceiver components that allows data transfer in real time to the host computer. FIGS. 19A and 19B are front and back views, respectively, of an example implementation of an e-clipboard for the Input and Control Device of FIG. 17, while FIG. 19C is a side view of the e-clipboard and PaperPlate. In FIG. 19A, e-clipboard 1710 has well 1910 for holding a PaperPlate and attached paper locking device (clip) 1718. Hotspots 1760 allow command and control information to be exchanged with the host computing device. In FIG. 19B, magnets 1920 hold the PaperPlate to e-clipboard 1710 and pop-hole 1930 is used to release the PaperPlate. Electronic components bar code reader 1745, battery 1750, and communication device 1755 are shown exposed for better understanding.

FIG. 19C depicts the two major parts to the ICD and indicates how they fit together. PaperPlate 1705 is the top part, with the form instances held by clip 1718, and the bottom part is e-clipboard body 1710, with all of its components, such as radio 1755, the indicator LEDs, the pen detection system, battery 1750, the battery charger port, barcode reader 1745, magnets 1920 for holding PaperPlate 1705 in correct position and registration and PaperPlate detection switch 1940. In addition, pophole 1930 allows easy removal and placement of PaperPlate 1705 into and out of e-clipboard 1710. Two holes 1950 near the top center allow the rivets or other fasteners that hold clip 1718 onto PaperPlate 1705 to seat correctly on e-clipboard 1710 are also shown. Finally, well 1910 that helps magnet system 1920 hold PaperPlate 1750 securely in the proper position is visible.

In the currently preferred embodiment, the e-clipboard is a lightweight device, weighing under two pounds, that is able to dock the PaperPlate in a specific and constant position and able to transmit the writing implement position relative to a constant x,y coordinate system in real time to the host computer. It has x,y dimensions slightly larger than the paper being used, is ergonomically easy to carry and hold while writing or drawing on the paper, and has functional components that will not obstruct writing. Ideally, the power supply is a rechargeable battery, with sufficient charge capacity to run the electronic components for a useful length of time, usually a 8-12 hour work period. The e-clipboard performs the functions of capture of writing implements movements, both in the x,y plane and the pen up/pen down, transmission of the writing implement movement wirelessly or through wires to the host computer, and providing hotspot capability for computer command and control without the need for other interface means, such as keyboard and mouse. Furthermore, the e-clipboard has a means of docking and holding the stacks of forms or paper that the user will write and draw upon.

In this embodiment, the capturing of writing and drawing by the user is accomplished by triangulation of distances in real time using ultrasonic waves (see, e.g. U.S. Patent Application Pub. 2003/0173121: Digitizer Pen). In other embodiments, this may be accomplished by other means, such as by magnetic induction (see, e.g. U.S. Pat. Nos. 6,882,340, 6,462,733, and 5,693,914, and U.S. Patent Application Pubs: 2003/0229857 and 2001/0038384) or by optical sensing. The captured writing location or digitized pen data is then transferred to the host computer, which in the preferred embodiment is via a wireless connection. In this invention, the ability to send and receive data in real time generates the possibility for host computer control using both the writing on the paper forms, as well as using “virtual hotspots” located on the forms or outside the forms on the e-clipboard. This invention utilizes the positioning of objects relative to other objects, such that every time the objects are brought into proximity, their relative positions are fixed and held. In addition, the positioning mechanics are such that the objects may be held only in a single way. The invention uses three precise positioning and locking mechanisms to achieve this objective.

FIGS. 18A and 18B are front and back views, respectively, of an example implementation of a PaperPlate for the Input and Control Device of FIG. 17. In FIGS. 18A and 18B, PaperPlate 1705 has clip 1718 for holding stacks of forms. Washers 1820 interact with the e-clipboard magnets to hold PaperPlate 1705 firmly to the e-clipboard. In the preferred embodiment, PaperPlate 1705 holds multiple sheets of paper in a specific location in such a way that the x,y coordinate system is maintained upon removal and replacement of pieces of paper. Further, the PaperPlate allows for easy and fast changes of paper by making it possible for rapid set up of different stacks of paper to be placed in the device by preloading a series of PaperPlates for later use in the same e-clipboard. The PaperPlate is ideally the same width as the paper, and the height of the plate up to the clip is slightly (0.01-0.3 inches) more than that of the paper. Rigidity of the plate ideally is, at a minimum, sufficient to hold the paper vertically without significant bending. Ideally, the plate resists bending without undue effort. In the preferred embodiment, the holding clip that secures the stack of paper on the PaperPlate may be opened and closed with one hand. It holds up to 100 sheets of paper firmly and is light weight (less than one pound when not loaded with paper).

For standard letter sized paper (8.5×11 inches), the PaperPlate of one embodiment is made out of aluminum plate roughly 0.1 inches thick, with a width of 8.5 inches and a height of about 11.5 inches. These dimensions allow the plate to be sufficiently rigid as to resist bending, while keeping the weight to a minimum. In addition, the aluminum plate is the exact width of the paper used in the invention. The PaperPlate and corresponding e-clipboard may be modified in size to accommodate other size paper, such as 8.5×14 legal size paper. The materials used are not unique, critical or mandatory, however, as the types of materials are important only in that they allow the invention to achieve the specification. While the preferred embodiment is described as being comprised of particular materials, it will be obvious to one of ordinary skill in the art that the described materials are not the only ones that might be used and that any of the many suitable materials available may be advantageously employed in the present invention. In addition, the measurements of the disclosed design are not critical or mandatory, other than that they achieve the stated specification.

The PaperPlate allows the positioning and holding of a piece of paper or a stack of paper in x,y space such that the x,y coordinates are consistent with the x,y coordinates of a appliance/input device. Additionally, the invention allows for easy placement and removal of the paper from the device, ideally with a single hand. Furthermore, the locking of the paper in place is accomplished with a minimal amount of effort and time requirements. The alignment of the paper on the plate is achieved by stacking the paper on the plate, holding either side of the PaperPlate with the paper with either hand, raising the PaperPlate with the paper vertically and gently tapping on a solid flat surface, allowing the paper to align with the edges of the plate. Upon alignment, the user is then able to hold the PaperPlate and the paper stack with one hand and fasten the clip to hold the paper securely. This constitutes the paper preloading step.

The docking of the PaperPlate into the e-clipboard is accomplished in several ways, one of which is shown in FIGS. 20A and B. In FIGS. 20A and B, body 2010 of the component case of e-clipboard 1710 acts as a guide to allow the user a means to rapidly place or slide PaperPlate 1705 into the correct position such that magnets 1920 on e-clipboard 1710 draws washers 1820 located on the back of PaperPlate 1705 into well 1910. Magnets 1920 also server to hold PaperPlate 1705 firmly in the correct position in well 1910. Also visible in FIG. 20A is switch assembly 1940 that detects the presence or absence of PaperPlate 1705. The e-clipboard holds the PaperPlate securely, docking with sufficient attachment strength to be held or shaken lightly in any position with the maximum amount of paper without un-docking. The PaperPlate docks and undocks into the e-clipboard with minimal effort with one hand.

The correct positioning of the PaperPlate on the e-clipboard is achieved in the preferred embodiment by three mechanisms; however, any other means known in the art such as latches, might be used to secure the plate in the position needed. First, the e-clipboard has a slight depression or well into which the PaperPlate fits snuggly. Secondly, the PaperPlate and the e-clipboard have magnetic materials that help align and hold the two Parts together in register. In this embodiment, the PaperPlate has thin steel washers and the e-clipboard has magnets in corresponding locations. In addition, the magnet materials are offset such that putting the PaperPlate in upside down will not allow the PaperPlate to slide into the well. Thirdly, the e-clipboard has raised covers that are flush with the well walls, so that, as the plate is brought into alignment with the covers, it naturally drops into the well. In the current embodiment, an access hole is cut through the e-clipboard, allowing the user to gently push the PaperPlate out of the well, thereby generating a means to rapidly and easily grasp the PaperPlate and remove it from the e-clipboard.

The preferred embodiment of this invention requires the ability of the device to determine the actual page or form being viewed and/or written upon by the user within a stack of pages. Multiple approaches may be used for page detection, such as various means of page encoding. The preferred embodiment utilizes barcode technology to identify the currently viewed page. FIGS. 21A and 21B are side and top views, respectively, of an example implementation of a bar code reader for use in an embodiment of an Input and Control Device according to the present invention.

The position of the barcode on the form requires that the barcode reader be able to “read” the barcode normal to the plane of the paper. Due to the constraint that the paper has to be flipped out of the way in order to observe sequential pages beneath the page on top, there should not be any physical obstruction vertically above the stack of pages. One option would be to position the barcode reader such that it is vertically above the paper stack, with sufficient room to allow page flipping. This approach was not taken due to the increased height of the overall e-clipboard, thereby reducing its portability and the visibility of the paper by the user.

In order to achieve the needed angle from the normal and the focal length, the barcode reader light path was adjusted using a two mirror system, as shown in FIGS. 21A and B. Top mirror 2105 and lower mirror 2110 are positioned precisely such that the light emanating back from the barcode on the paper is in focus and of sufficient strength due to the correct angle of the light path to the normal of the barcode. The angle required will vary depending upon barcode reader 2115. By incorporating mirrors 2105, 2110 and barcode reader 2115 in the same functional assembly, replacement of the system can be done by swapping out a barcode assembly and replacing it with another through the manipulation of two screws or other fasteners in tapped fastener holes 2120. By this means, the correct angles and distances of the mirrors and barcode placements are accomplished prior to inserting the assembly into the e-clipboard housing.

As shown in FIGS. 21A and 21B, mirrors 2105, 2110 are held in place by fastening them to a housing that consists of platform 2125 and sidewalls 2130. Lower mirror 2110 is mounted on shelf 2135 and top mirror 2105 is mounted on sidewalls 2130. Control of the barcode reader may be accomplished through connection port 2140 to a control board via a ribbon cable or other means.

For this embodiment of the present invention, the barcode reading capability must be achieved in a manner that is not blocked by pages that are held up by the user, as he/she leafs through the stack of pages. Importantly, the barcode reader must “see” only the page directly below or behind the last page being held up by the user. Furthermore, the timing of the barcode read must be sufficiently rapid as to not miss a page “flip”. Ideally, the barcode reader device is lightweight and draws a low amount of current, thereby allowing the e-clipboard to be powered by commercially available rechargeable battery sources for an extended period of time, such as greater than 8 hours. The reader is ideally located so that the user is not prohibited from easily writing or viewing any or all of the pages on the e-clipboard. Location and reading angle to the printed barcodes should be such that page flipping or turning exposes the barcode to the barcode reader. Preferably the barcode reader should allow identification of individual pages in a stack of pages, should capture barcodes during page flipping at a rate sufficient to synchronize handwriting input to the correct page, and should utilize barcodes that have data content sufficient to identify the form type and the form instance.

Location of the Barcode reader assembly and the barcodes on the paper may be in any position near the interface of the device and the lower edge of the paper. In the preferred embodiment, it was chosen to locate the barcode reader on the lower left side of the device for right handed users (and the lower right side for left handed users) for several reasons: Generally, there is space at either lower edge of forms for a barcode. This space is generally unused and does not interfere with the printing of the form. A user will flip or raise the paper by grasping the bottom edge of the sheet of paper. By moving the barcode reader off center, the user has greater space to grasp the paper. Furthermore, by having an offset from the center (either right or left depending upon the handedness of the user), there is less chance of the user blocking the barcode reader as it is accessing the barcode on a page.

Concentrating the battery and barcode reader assembly in the lower left (for right handed users) also minimizes the effort required to hold the device. This is accomplished by moving the center of gravity nearer to the general point of holding with the non-writing hand. Commercial barcode reader engines generally have constraints on the focal length, the angle from the normal, and the width of a barcode at close distances that they can read. Because of these constraints, the physical shape of the barcode reader engine and the possible locations of the barcode on the paper forms, a barcode reader assembly was invented. This embodiment of the invention achieves two main objectives: it allows the barcode reader to be closer to the barcode than its focal length and it allows the barcode reader to read at an angle greater than its normal incident angle. It will be apparent to one of ordinary skill in the art that many other means may also be used to achieve these objectives.

FIG. 22 is a depiction of the light path of the bar code reader of FIGS. 21A and 21B. In FIG. 22, light 2210 emanating from barcode reader 2115 reflects 2220 off lower mirror 2110, then reflects 2230 off top mirror 2105 such that it strikes the lower edge area of the form instance in the paper tray at a relatively steep angle to the normal. The reflection 2240 of barcode 2245 travels back to barcode reader 2115 by first reflecting 2250 off top mirror 2105, then reflecting 2260 off lower mirror 2110 to reader 2115. The barcode reader is therefore mounted such that the light path to the PaperPlate and the printed barcode is bent 90 degrees. A series of two mirrors serves to both extend the distance between the barcode and the reader and achieve the angle to the normal for reading. In this embodiment, the light path from the barcode reader to the barcode allows placement of the barcode near the bottom edge of the paper, such that page flipping is not blocked by the barcode assembly. In a further feature of this embodiment of the invention, the barcode reader and the aiming mirrors may be mounted on an assembly that is easily adjusted and changed. This design allows the user to swap out assemblies and adjust the mirrors with a minimal amount of disruption to the remainder of the e-clipboard. While one embodiment is shown, it is clear to one of skill in the art that other means of identifying the form instance may or may not use light and may or may not require altering of light paths in order to achieve the desired reading capabilities.

The barcode symbols on each page of the paper stack are located in the appropriate place for the accessing by the barcode reader. In the preferred implementation, the barcodes are located near the bottom of the page on all pages in the stack of paper. These barcodes can optionally be preprinted on blank paper so that further printing of form materials would produce forms that contain the barcode. Alternately, the form printing process may print the barcode specifically on the form being printed. In this manner, a direct information link could exist between the form and the barcode. Information that might be included in the barcode would be date of printing, type of form, instance of form, workflow process identifiers and paper stack information.

The capturing of handwritten or drawn data by the system on multiple forms or pages in a stack requires the ability to know fairly precisely the timing of the page flipping and corresponding input by pen. For example, if the user is flipping back and forth between two pages in the stack, and writing on either one or both, the system needs to be able to identify which page is exposed during pen down actions. In this invention, several methods may be utilized to determine the currently viewed page and the page upon which pen down actions occur. One approach is to constantly monitor the identifiers, such as barcodes, on pages through an automatic barcode scan at a short time interval, such as a scan every 100-500 milliseconds. This allows identification of the viewed page at all times, and the pen down information that is captured will be synchronized with the barcode read. However, this is not an optimal situation, given that continuous barcode reading requires a significant amount of electrical power to illuminate the barcode, thereby reducing the lifetime of the battery in the device.

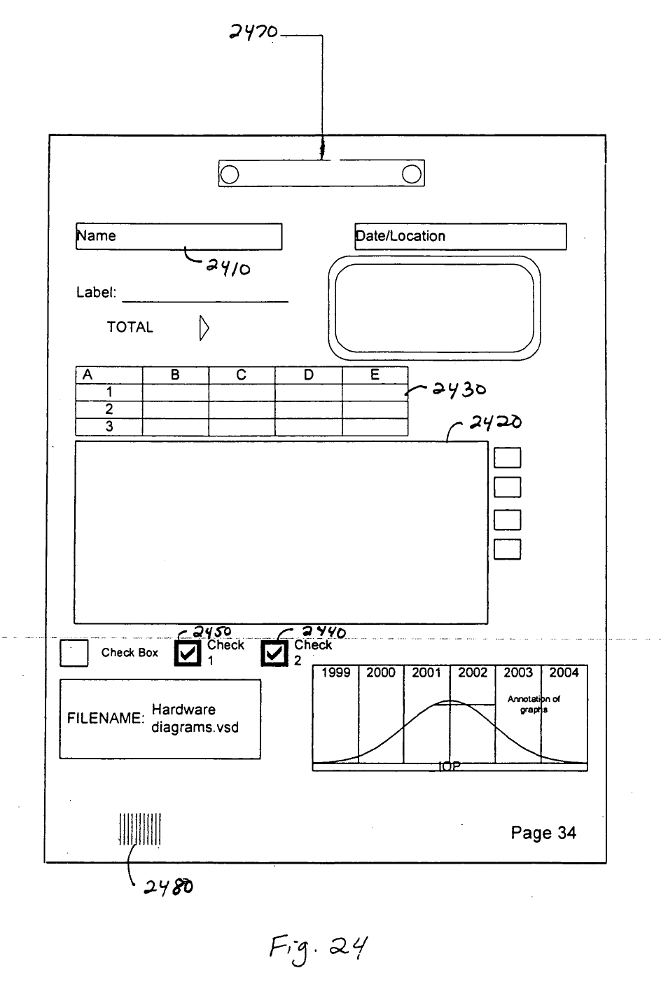

Alternatively, a barcode can be read based on a timing cycle that is controlled by the users writing (pen Down-pen Up-pen Down). FIG. 23 is a flow chart of the process of page-flip recognition and timing according to one aspect of an embodiment of the present invention. As shown in FIG. 23, the timing cycle (page flip timer) may be adjusted to the user's habits and the workflow. For example, if the user is rapidly flipping through pages and making small marks on each page, a timing cycle that is fairly short and informed by a pen down 2310-pen up 2320-pen back down 2330 movement, within a time greater than an adjustable specified timing cycle 2340, it will cause the firing of a barcode read 2350, followed by transmission of the barcode 2360 to the computing device. Alternatively, if the user writes sequentially on each page, while rarely flipping back and forth between pages, a longer timing cycle might be used to request a barcode. By measuring the time between pen Up and pen Down motions, a suitable timing cycle may be designed. It has been found that for a general user, with specific fields designated for data input, a pen up-pen down cycle of greater than about 1.5 seconds indicates the possibility of a page flip. In this case, if the user stops writing, even for an extended period, no barcode will be read until the user begins writing again. Upon resuming writing, if more than 1.5 seconds has passed, a barcode is read.

An alternate means of determining page flipping incorporates a page movement sensor, such as an optical or physical encounter device, such as a small light device with sensor, detects close motion. The combination of the edge of the page moving past the sensor with the pen Up-Down cycle allows capture of page flipping and writing synchronizing.

The program that monitors the pen Up-pen Down cycles may reside either in the device itself, or in a host computer that is receiving the pen input. Either approach has its advantages. The detection of the pen or WI location on the surface of the paper may be accomplished in multiple ways, including but not limited to: Ultrasonic detection, as in the Pegasus PC notetaker product, through paper digitization using touch sensitive, magnetic induction screens, and using Electromagnetic resonance technology (e.g. Wacom and AceCad tablets). With technologies that use a triangulation approach, such as the Pegasus notetaker, the positioning of the detectors have to be such that the pen-detector path is not blocked. This may be caused by the user's hands and arms as well as clothing. In addition, and importantly for the present invention, the paper that is flipped up will itself block the ultrasonic detection of the pen location. Hence, a feature of the preferred embodiment of this invention is proper placement of the detection equipment relative to the writing surface. For a right-handed person, the detection using ultrasonic means is achieved by placing the detectors in the lower left side of the apparatus. This provides a clear line of detection between the pen and the detectors at essentially all points on the page. Page flipping during writing does not block the detection as the user is writing, because the pages above the page of interest are moved well beyond the detection path.

With a magnetic induction or touch sensitive type detection system, such as the Wacom tablets, the detection path is captured directly through the surface of the tablet. However, the identification of the page upon which the writing is occurring is still an issue, and requires the use of the barcode reader or other means for page identification. One embodiment of the present invention incorporates the barcode reader assembly and pen timing cycles with a magnetic induction tablet. In this manner, pen movements and handwriting and drawing is captured, and the page identity is known by the ICD.

In one embodiment, the code for the pen capture, the barcode reading, and the required computational capability is resident on the e-clipboard. This “ICD Centric” embodiment has the advantage of not needing a host computer to receive and store the user input. This allows a completely mobile setup, without the constraints of having the host computer necessary during data acquisition. The data is stored for later download into a system that allows visualization. However, a limitation of this approach is that the user is not able to observe the input until the download occurs, hence, if there is data missing or if the user needs to edit or change the input in real time, he/she is not able to do so. This system would be particularly effective for manufacturing inventory workflows, where batch retrieval of input data is captured and stored seamlessly.

Having the host computer control the barcode reading as well as accept the writing input data in real time (a “Host Computer Centric” approach) allows more flexibility for adjustment of the page flip timer by the user. As mentioned, the work flows and user profiles dictate the need for adjustment of the timing cycles used to capture barcode reads, and hence to monitor page flipping. With the program controlling the timing cycles resident on the host computer, easier manipulation of the timing cycles is possible, even to the point of having a heuristic program monitor the barcode reads and the correct input of data into fields on different forms. Furthermore, the user is able to monitor the input in real time and make adjustments in page flipping behavior if necessary. With a host computer and a screen, the user is also able to monitor his/her input, and therefore to make edits or corrections in real time. Additionally, the host computer in this embodiment has the capability of assisting in decision-making and error checking in real time through alerts and flags to the user.

One of the important advances provided by the present invention relates to the integration of information capture and workflow. By integrating pen based information capture for a specific cycle of the workflow, the amount of extraneous and added work required to capture data per workflow is minimized and harmonized with the workflow itself-providing a superior platform to mouse and keyboard based data entry which are intrusive and extraneous to the workflow. In the present invention, that results in a “stack” of paper (forms) on the e-clipboard that is only relevant to that single cycle of the workflow. The forms represent the workflow and information to be captured. For example, in a medical practice, a single patient visit represents a workflow for the physician, possibly with sub-workflows, such as various testing processes. Hence, the stack of forms on the e-clipboard will be limited to those needed for data entry for that patient during the specific visit. However, the ability to access information by the user should not be limited. The pen-based computer control provides access to the specific patient's medical records from previous visits, as well as to other medical information sources, such as drug interaction web sites, insurance information, billing and scheduling.

The ability to specifically tailor data input and forms to a single workflow cycle in many cases requires the rapid and efficient “unloading and loading” of the paper or forms from and into the e-clipboard for the subsequent cycle. Furthermore, in many cases, the information generated during the workflow cycles need to be kept separate. In the preferred embodiment, the ease of paper form manipulation using the PaperPlate allows for addition or substitution of forms during the workflow. The barcode information described herein further allows for the host computer to recognize that there has been an addition or substitution of forms by the user during a specific workflow. By utilizing a barcode symbology that includes a form definition and form instance that can be tied to specific records in a database, the system can be programmed to keep information that is entered on one form or into one stack of forms separate from that entered on another form or stack of forms. Importantly, by indexing the barcodes and form instances during the initial printing process, the end user isn't required to enter any metadata about the forms.

The present invention provides the user with multiple modes of saving and filing input. These include the primary hardcopy, which is the paper (or other surface) upon which the user has written, drawn or painted, thereby inputting data, information or graphics. The primary softcopy may contain multiple parts or files that together reconstitute an image or electronic copy of the Primary Hardcopy. At a minimum, if the primary hardcopy form is a blank paper or surface, the primary softcopy might contain only the input of the user. If, on the other hand, the user is inputting data, information and drawings into an extensive form with many defined fields, the files that are integrated might include the form type, the writing input files and any graphics input files that correspond with that primary hardcopy.

After the primary softcopy is saved, certain parts of the primary softcopy may be further manipulated to facilitate other uses of the input data, e.g. conversion of handwriting to output text via character recognition software. The user may then make corrections or additions to the primary softcopy using keyboard, mouse, stylus, microphone or other input means. Furthermore, the writing input may be deciphered using character recognition; check marks or other symbols may be interpreted as specified by the form and entered into a database, and drawings may be cataloged and/or compared with drawings from other form instances. The primary softcopy may be further modified for better use through the addition of hyperlinks to useful sites that provide more information about the input data, introduction of graphics, tables and pictures and the addition of sound files, such as recorded voice files for later transcription and/or voice recognition, thereby making it a more useful interpreted softcopy. These modifications, additions, and/or comparisons may be added by the person or people that provided the original input, by other users, or automatically by various computer applications.

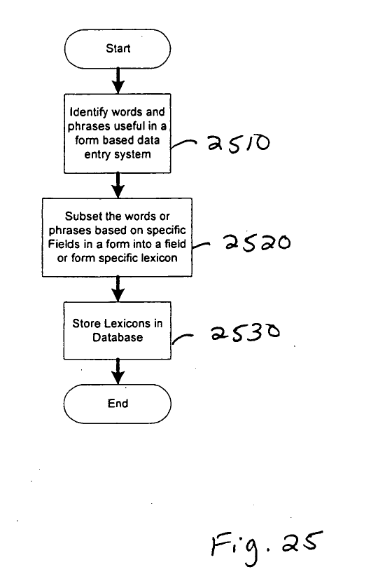

FIG. 24 is a depiction of an example form as it appears on a PaperPlate, according to one aspect of the present invention. In FIG. 24, a number of the various options that may be contained on a form, including a number of data fields 2410, 2420, 2430, check boxes 2440, 2450, and the identifying barcode 2480, are depicted. The fields may be used for data entry, graphics, and the like, or as locations for the user to control the computing device. The form instance held on the PaperPlate also shows the clip 2470 that holds the forms securely, as well as the demonstrating that the PaperPlate optimally has dimensions that make it of the same width as the paper on which the forms are printed. This allow for easy positioning of the forms so that, when the PaperPlate with the forms is placed into the e-clipboard, the registration of the forms will be exactly (to within about mm) known.

For certain applications of the ICD process, especially in form-based documentation situations, such as health care information gathering, electronic medical records, legal recording, insurance claims processing, clinical trial management, marketing research, and the like, each field in a form may have a limited field-specific vocabulary, i.e. a predefined vocabulary of input words, symbols, drawings or lines. As a simple example, a date field containing the input of the “month” has only twelve possible full text names (January, February, etc.), and a limited list of numbers (1-12) and/or abbreviations (Jan. Feb., etc.) These limited vocabularies can facilitate character recognition by optical character recognition (OCR), intelligent character recognition (ICR), or handwriting recognition (HWR) systems. Hence, another optional feature of the present invention is the ability to use very restricted vocabularies defined by users or user groups for each field in specific forms in order to allow efficient and customizable character recognition. This field-specific character recognition may be further customized by users for their own use, thereby greatly facilitating data accuracy and input efficiency for each individual user.

Fields therefore will often have a limited set of entries that are allowable. In the case of handwriting and machine text, those limitations result in a lexicon of allowable words or phrases. Several approaches may be used to develop those field specific lexicons that have utility for both defining the possibilities for entry and, in the case of handwritten words and phrases, increasing the accuracy and efficiency of the handwriting recognition engines. Those approaches include, but are not limited to, having domain experts list all possible words and phrases that might be useful in filling out any forms related to their specialty (domain lexicon) and then segmenting those large domain lexicons for each form template and further for each field within a form. Domain knowledge also allows the building of semantic relationships between fields and words, allowing sophisticated rules for data entry as well as enhanced intelligent data searches and mining. Additionally, lexicons are available, both commercially and as open source, which provide complete sets of words or phrases. An example for the medical community might be the SNOMED lexicon of medical terms. These large lexicons may be imported to be used as domain lexicons. Alternatively, the end users, based on domain knowledge and experience with a form set, might list all words or phrases that he/she has used in a specific form or field. In either approach, the lexicons are saved to the database to be linked to the form and fields where appropriate. Furthermore, the lexicons act as the set of words or phrases that end users may input to train the system to recognize. In the current embodiment, a combination or either approach is used, depending upon the complexity of the domain lexicon and the number of form templates. Generally, having a domain lexicon is a useful starting point for end users to specifically design form and field lexicons.

FIG. 25 is a flow chart of the process of developing and storing application-specific lexicons according to one aspect of an embodiment of the present invention. In FIG. 25, words and phrases useful in a form-based data entry system are identified 2510. The identified words or phrases are then divided into subsets 2520 based on specific fields, to obtain a field or form-specific lexicon. The lexicon is then stored 2530 to a database.

As a practical matter, the present invention is most effective when the computing device has been trained to recognize the handwriting of each individual authorized user. The handwriting inputs received from the ICD are then compared to stored samples of the specific user's handwriting taken under various conditions. FIG. 26 is a flow chart of the process of training a computer to recognize a user's handwriting according to one aspect of an embodiment of the present invention. In general, the accuracy and efficiency of handwriting recognition is enhanced through the use of limited lexicons. Furthermore, in some cases, the enhancement of recognition may be increased through providing specific examples of an individual's handwriting. In FIG. 26, the user enters 2610 examples of individual words or phrases belonging to specific lexicons. Those examples of writing are then stored and linked 2620 to the words or phrases they represent. The resulting linked examples and words/phrases may be considered the training sets. The recognition engines may or may not utilize those examples and training sets in the recognition algorithms.

Statistical analysis 2630 may optionally be performed on the training set to identify the examples for each word or phrase for each user that increase the recognition engine's accuracy and or efficiency. For example, a training set may be reduced in size if several of the examples have extremely similar pen strokes. A single example of the very similar examples would then be saved, rather than multiple examples. This approach reduces the training set size without sacrificing accuracy, resulting in a more efficient use of computing time. Additionally, the user may optionally want to allow his or her training sets to evolve with time. This might occur through repeated trainings 2640 separated in time. Alternatively, the actual input of specific words or phrases in fields on form instances may be captured and used to augment the training sets. The sets may be reduced in size by removing either older examples or, as noted above, examples that have close replicas. In this way, the training sets are allowed to evolve with the user's writing and/or word and phrase preferences.

One advantage of the preferred embodiment of the present invention over keyboard and mouse-based systems is that the user produces a primary hardcopy of the form instance. This primary copy has utility for documentation and validation of the computer-based input. For example, possible tampering with the computer files is readily checked by comparing the primary hardcopy to the computer-generated version. Furthermore, system problems, such as power, memory, or storage loss, can be ameliorated by utilizing the primary hardcopies of form instances as backups. Furthermore, people that do not have access to computing devices or to the stored information may still use the primary hardcopy in the workflow. For example, the primary hardcopy may be given to an assistant for retrieval of material, or it may be used to provide immediate instructions in a work setting that is not conducive to computer access, such as at a construction worksite or in an emergency situation. Furthermore, some tasks that are separated temporally may sometimes be better accomplished with a written note than with a file resident upon a computer drive that requires access and the human memory.

Document lifecycle management may be adjusted to account for the co-existence of primary hardcopies with the computer stored, controlled, and retrievable primary and interpreted softcopies. For example, medical offices might archive the primary hardcopies in storage off site, retaining only primary hardcopies that are “live” (being used for input). The primary and interpreted softcopies would then be retrieved whenever a user needs to refer to previous input. Specific fields from the primary and interpreted softcopies additionally may be captured into databases for further data mining and display capabilities. With the present invention, data storage may be localized in one place, on a computing device, a server, or a network, and hence is easily controlled and archived.

To minimize inappropriate dissemination of critical or personal information stored on the computing device, the device may utilize security measures such as firewalls, virus protection software, and data encryption. A further option for minimization of chances of data theft is minimization of the time that the computing device is connected to the internet or outside network. If the flow of data between the specific computer and the internet or network occurs only for a minimal amount of time, sufficient for the data transfer and no more, the chances of having information stolen is reduced, and, if the data streams are limited in scope, then the sending and receiving computers can be alert for data files that are not of the same data type. A particular benefit of the present invention is that data is transferred along direct communication paths that capture only the form ID, which is an identifier that matches a key that is held in the host computer, and the real time pen coordinates. Further encryption is possible with this information for even greater security.

Particular benefits arise with the present invention because the computing capabilities are separated from the input devices and the computing devices may be separated from internet connection devices. Hence, a minimum of three physical separations is possible with this system. Each separation allows for both physical and virtual security measures to be implemented. In one optional implementation of the present invention, each ICD is programmed to recognize only a single or limited number of WIs, thereby limiting access to any computing device to the limited pair of devices. For example, the WI may contain the means for identification—such as a RFID or other physical entity, that identifies the WI to the ICD. In that manner, only the WI that is specifically identified as being a WI for the ICD will produce writing, drawing or painting that is captured through the ICD to the computing device.

Furthermore, each ICD may be designed to interact only with a single or a limited number of computing devices, again reducing the possibilities for inappropriate access to sensitive materials stored on the computing device or system. This would also render the ICD useless if stolen or used with other computing devices. Similarly, the computing device may be programmed only to respond to as many or as few of the ICDs as the system needs. Likewise, the computing device(s) may be designed to only interact with a single, or limited number of ICDs, thereby limiting any possibility of access to data stored on the computing device or related networks. The computing device also may have a limited number of other computational devices or networks with which it may interact, such as the internet via firewalls, Virtual private networks, and temporal openings. Furthermore, software protocols on the computing device may limit access to other computers, networks, or intra and internet sites.

The ICD communication with the computing device may be encrypted to any standard or level deemed necessary. Furthermore, each ICD may be provided with a digital code that is only recognized by its computing device, and vice versa. Hence, an ICD can be made to function only within the range of its assigned corresponding computing device. Based on this, an embodiment of security levels may be established that limits the access of the computing devices to the main data storage or central server, such that the access to the central server occurs only at specified times, in specified sequences, or at specified levels. Removal of need for each user to be physically connected to an outside system increases internal security. Encryption of the signals traveling from the ICD, may be hardwired or software controlled in the computing device.

Further means for securing data may be incorporated, such as the implementation of business rules for user identification in order to obtain access to, and utilization of, specific form instances. For example, only certain users might be able to enter data on a particular form instance. In this case, through password, signature, biometric or other identification means, the system would capture the appropriate user's input, whereas not allowing other users to input data. Systems could be developed to trace the data input to specific validated or non-validated users, based on identification, time, and handwriting analysis.

A key aspect of the present invention is that the ICD contains only the writing surface, the detection hardware to turn the input signals (spatial and temporal determination of the contact with the surface by the WI, the surface or form data, and a user identification capability) into a digital signal that may be sent via wired or wireless means, and a source of power to run the device. The detection mechanism for the WI may utilize any of many means known in the art, including, but not limited to ultrasound, infrared, magnetic, optical detection of surface attributed, touch or pressure sensor detection, and radio-frequency triangulation. All computation, including character recognition, storage and transformation of data, diverse drivers, etc. resides in the computing device, or on the network to which the computing device is connected. Because of this segmentation of input and computation, the power requirements, the size of the power source for the ICD, and, importantly, the cost and complexity of each ICD is therefore kept to a minimum. In addition, since multiple ICDs may interact with a single or multiple computing devices, costs for implementation of such systems are kept low.

Many of the functions of the present invention are advantageously implemented in the preferred embodiment in software on the host computer and/or in firmware on the ICD. The currently preferred embodiment employs a PostgreSQL database, but other suitable databases include, but are not limited to, MySQL, Sequel Server, Microsoft Access, and Oracle. As a software platform, the currently preferred embodiment employs a Linux backend and Microsoft Windows front end, but other suitable platforms include, but are not limited to, Unix, Linux, Windows, and MacOS. The currently preferred embodiment of the software is implemented in Java for application code, database interactions—JDBC Java—Swing and SWT for GUI, WebServices in Java for communications, C for some computations (Energy Minimization and Chain Code), JavaScript for some front end visualization, XML for data transfer, and HTML for some GUI applications, but any other suitable language known in the art may be employed, including, but not limited to, Code implementations, Assembly, C, C++, Java, Perl, Visual Basic, JavaScript, XML, and HTML. The currently preferred embodiment of the firmware is implemented in Assembly for 8051 processor and C, but any other suitable language known in the art may be advantageously employed. The currently preferred embodiment of the software and firmware source code in ASCII format and a brief description thereof may be found on the accompanying CD-Rom and content list filed herewith and incorporated by reference in their entirety.

In addition to the specialized hardware described previously, the currently preferred embodiment employs one or more of the following: Dell workstations and/or laptops, Linux laptop for portable server applications, Dell 2 cpu server, Canon scanner, Kodak Scanner, Dell printer, and HP printers. It is clear to one of ordinary skill in the art of the invention, however, that any similar commercially-available hardware may be substituted for the devices listed.

Users of the present invention require no special training. The minimum knowledge and training is the ability to read and write. In the present invention, typing skills are not a prerequisite to efficient data or information input. For more advanced interactions with the computing device, form specific movements or symbols allow the actual control of the computing device by the user of the ICD. By observing a screen and the computing device response to commands on the ICD, the user may utilize the information and graphics resources of the computing device and/or the network with which it is operating. This interaction will then allow access to information and data that might be of use for the user during the input of data and information.

FIGS. 27-33 provide examples of some of the types of screen views with which a user might interact. FIGS. 27-29 are three example views of the type that might be seen during normal operation of the system when using the pen system to capture data. In these views, the primary softcopy may be displayed for real time input visualization. Furthermore, the screen may be split to show both a primary softcopy and an interpreted softcopy. Additionally, the screen may provide other applications, including word-processing, spreadsheet capabilities, and data visualization, and/or visual or graphic renderings of useful information.

In FIG. 27, on the right of the screen is example form 2710, in this case the Advanced Beneficiary Form. On the left is potential screen space 2720 available for showing further information and/or functions. The thin strip on the far right of the screen shows menu board 2730 with icons 2740 linked to physical geographic sites on the e-Clipboard. Manipulation of each icon 2740 can invoke specific functions, such as moving from page to page or enabling access to other information sources such as lab results, images, previous visit history, patient demographics, and the like, and can be activated either by pen down movement over the specified geographic space on the e-Clipboard or by mousing and clicking over the icon on the screen. As the user writes on the paper form on the e-Clipboard, electronic ink data is captured on the form image on the screen, creating a real time one to one correlation and feedback loop to the physical writing and creating an exact replica electronic document.

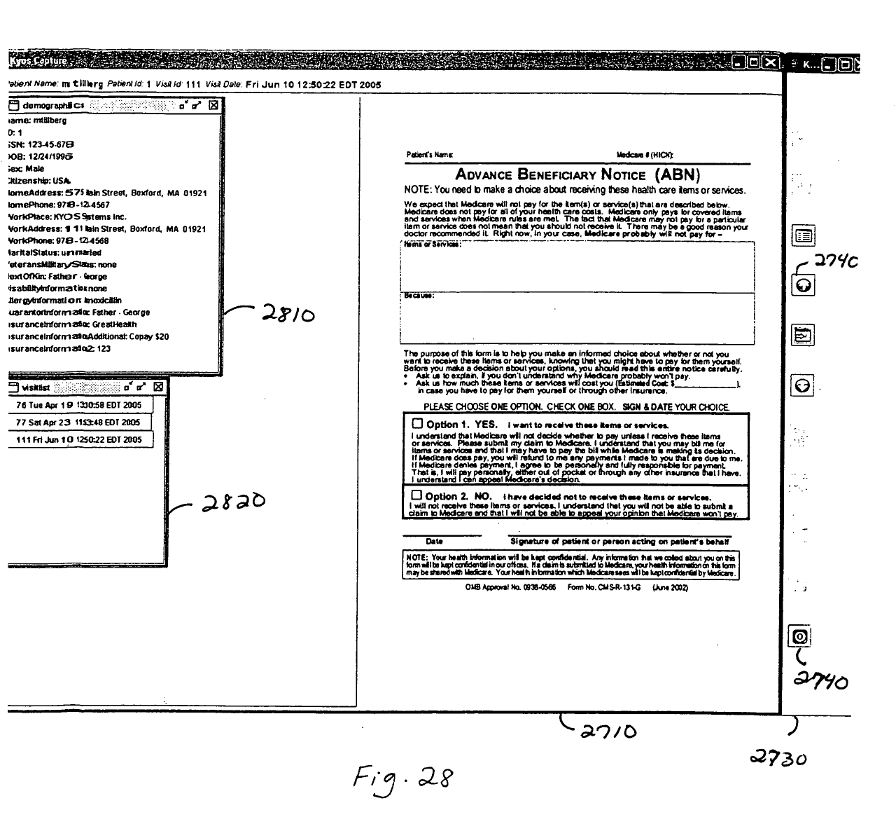

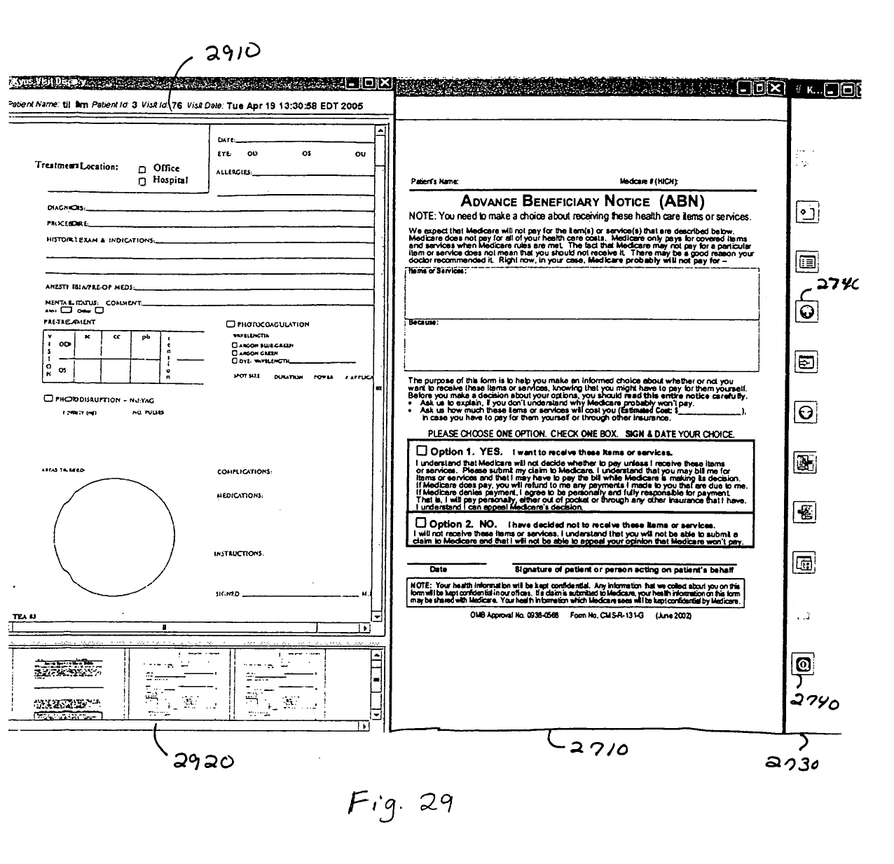

In FIG. 28, the screenshot shows the results of icon manipulation and activation through pen tapping on the e-Clipboard on specified hot spots. The retrieval of information is shown in the left hand side of the screen. In this case the user has called up patient demographic information 2810, shown in the top left box; the information within the box can have the patient's name, address, insurance status, and other desired or relevant information. Second, smaller box 2820 below it appears as a result of a second hotspot activation, in this case, pulling up historical patient visits. The ‘active record’ is shown in highlight. A second tap on the e-clipboard over the designated hotspot will open up that visit and make all forms used for that visit accessible for viewing and data mining. Hitting one of the other hot spots used for controlling vertical or horizontal scrolling can be used to select other historical records within that data set (popup box). In this way specific items within any scrolling menu can be easily selected and manipulated for access and viewing.

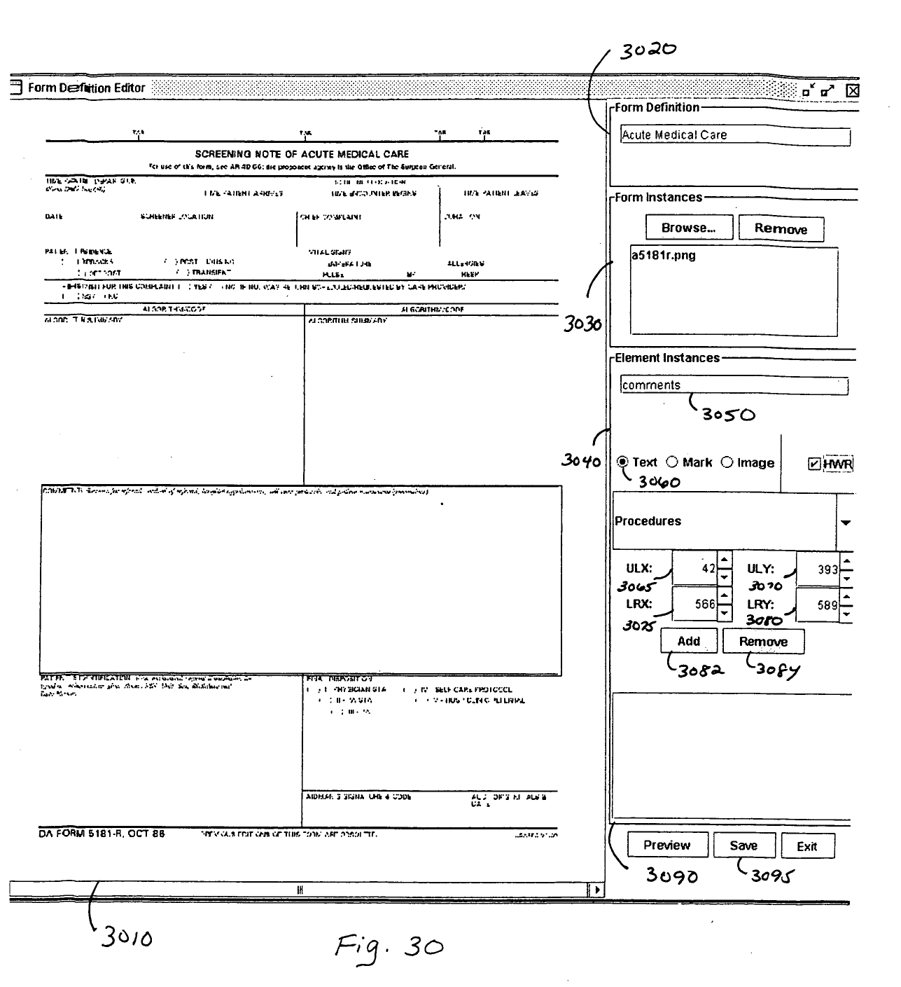

In FIG. 29, the screenshot shows the result of activating a previous patient visit. On the right hand side remains form 2710 that is currently being worked on and filled out by the end user. On the left hand side is one of the forms 2910 used in a previous visit. In this way all input can be rapidly viewed in the context of the form, providing for more rapid and rich understanding of individual patient information elements. Note on the left bottom of the screen the thumbnail images 2920 of all the forms for that previous visit. Users can rapidly tab, using either the pen over hotspots on the e-Clipboard or a mouse over the screen, in order to select and view individual forms in any desired order.

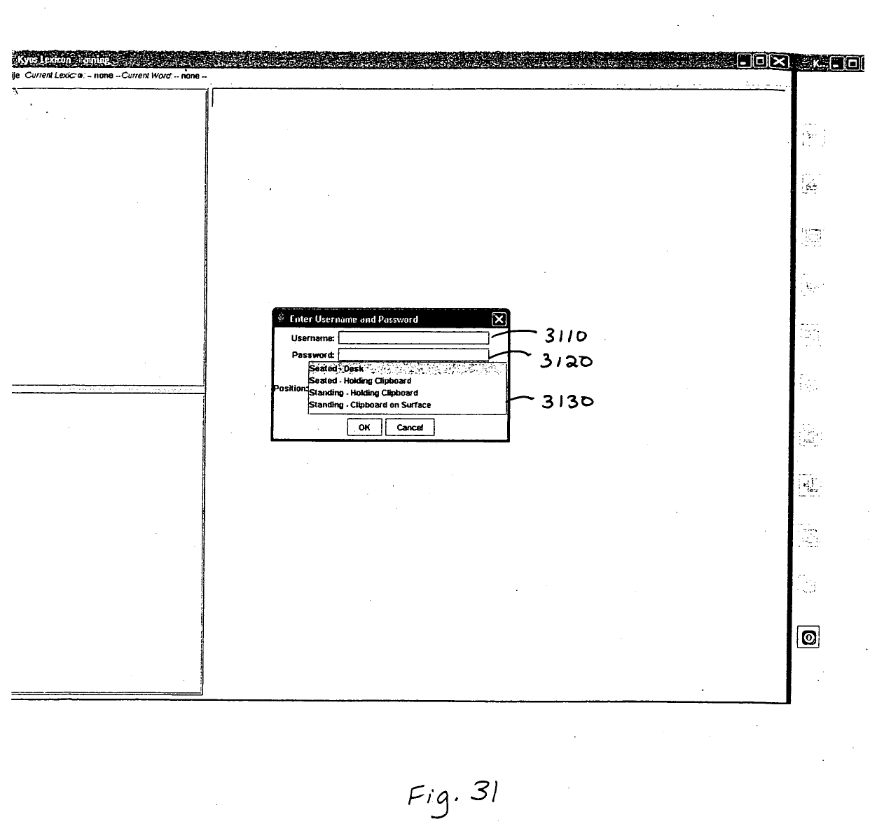

FIG. 30 is a view of a form definition screen according to one aspect of the invention. In FIG. 30, the screenshot displays the interface for KYOS Form Definition™ module. On the left is form 3010 that is to be defined and on the right is action menu 3020 where each form is defined, search engine 3030 allows the upload of a form to be defined, and specific fields or data elements (“Element Instances”) can be specified 3040. Element instance comment box 3050 allows the use of terminology or lexicons that can be used to define, identify, and search for that field for later data mining. Below that are a series of checkboxes 3060 that further instruct the program on how to deal with that individual data element instance; whether as machine text, optical mark, e.g., check box, image, or handwriting that is to be recognized. The ULX 3065, ULY 3070, LRX 3075, and LRY 3080 boxes show at the pixel level the definition of each box within the form to be specified. The user takes the mouse and using the left click button, creates boxes around specific fields to be defined and captured. Add/remove buttons 3082, 3084 allow users to correct mistakes in boxing specific fields. Once a field is boxed in this way, if Add 3082 is selected then the field and its definition is added to the list in box 3090 below and becomes a saved feature for that particular form. “Save” button 3095 on bottom allows the user to save the work to the server.

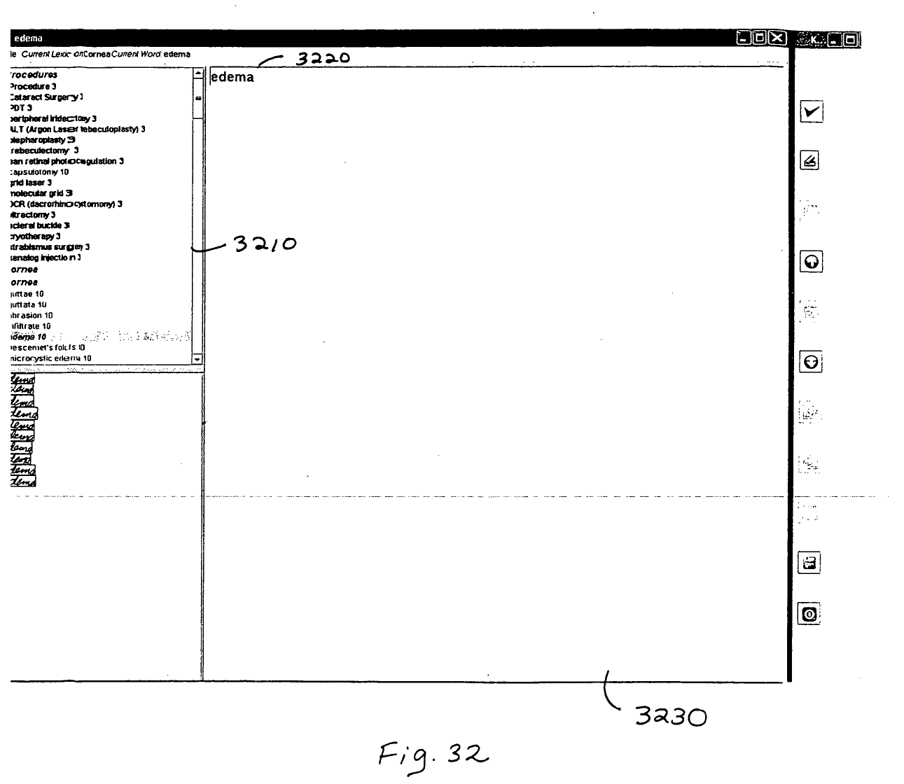

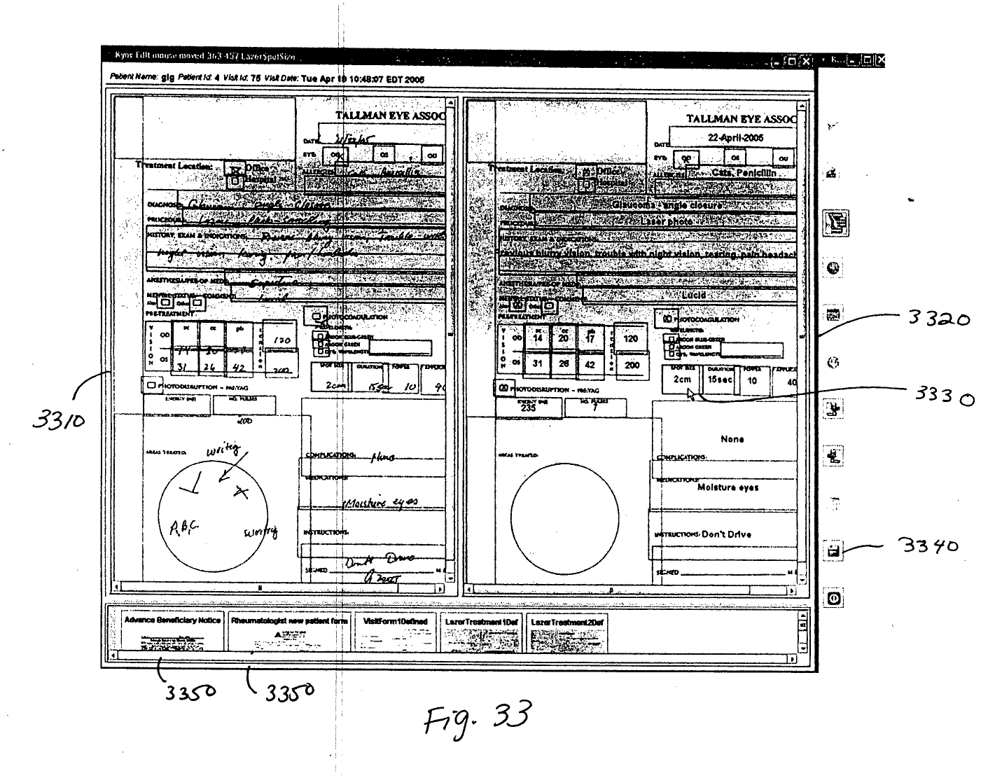

FIGS. 31 and 32 are views of example screens for training the computer to recognize a user's handwriting according to one aspect of the invention. In FIG. 31, the screenshot shows the log in process for KYOS Lexicon Training. Once on the server, the user is asked for his/her username 3110 and password 3120. Dialogue box 3130 also asks if the user intends to train the system from any one of a number of positions, since body position can impact the angle and speed of writing, which can be important factors in recognition. Once logged in the user can then use the File selection to pick the lexicon they wish to train their handwriting to.

In FIG. 32, the user has selected the “Procedure” lexicon 3210 to train. The list of words within the “Procedure” lexicon is shown, along with the number of handwriting samples collected for each word (the number next to each word in the lexicon). The system tracks each handwriting sample and matches it to its cognate text word so that example writings are matched to their requisite output. The selection of a particular word for training 3220, in this example being “edema” (shown by shading on the left and on the top of the screen in machine text), allows the user to write edema onto paper using the e-clipboard system and have the handwriting appear 3230 on the screen as immediate visual feedback. If the handwriting sample is judged acceptable, the user uses the pen to activate a “save” function hotspot on the e-clipboard or by mousing over the corresponding icon on the screen and clicking. Examples of past captured handwriting samples of edema are shown in red boxes around each individual sample on the left lower part of the screen.

FIG. 33 is a screen shot of an example visual display that may be seen by a user during editing of the captured and interpreted data. As seen in FIG. 33, after a workflow is completed, e.g., a patient visit, the end user or administrator can rapidly view the input forms and the output recognition via this split screen viewer and module. On the left is electronic ink handwritten input 3310 for that form, while on the right is recognized form 3320 where handwritten input has been run through recognition engines and converted into machine text on a field-specified basis. This split screen setup allows designated users and administrators to rapidly compare input data with output data in order to check and correct the accuracy of recognition or input. The fields to be captured and processed are outlined and are identical in both images. Box 3330 with the cursor on right form 3320 corresponds to the field being examined and edited on left form 3310, so the user can rapidly tab from field to field and know which field is active and to be worked on. Fields can be defined as being editable or not, e.g., hand drawn images. Users make changes by typing into the selected field. Drop down menus with approved lexicons can be added and used in each field so that business intelligence can be built into each field and field relationship. Changes can be saved by mousing over and clicking on save icon 3340. Thumbnail images 3350 for all the forms used in that workflow and patient visit are easily viewable on the bottom of the page and are selected by mousing over and clicking. Note that, on right form 3320, a number of fields and checkboxes have additional entries relative to the native input form on the left. Thus, users and authorized administrators can both edit and add new information into the recognized form. Changes and other entries are time stamped and linked to user and password authentication. The system can optionally require the use of digital signatures for further authentication, as well as machine stamping and other security and audit trail enabling features.

User efficiency with the ICD system should be very high, both in comparison to other computer input means, and with retrieval and usage of stored information. Form input by writing is very rapid and intuitive, allowing users that are not previously familiar with the forms to utilize them immediately. No special knowledge about operating systems and applications is needed, making the system very efficient for entry of data and information. Customization of the interactions between the user and the computing device allows natural language and notation usage, as specifically defined by each user. Personal and field restricted vocabularies allows for personal shorthand to be the field input.

An advantage of the present invention is its portability and physical robustness. Each ICD weighs significantly less than conventional laptops, tablet or slate computers, perhaps less than one pound. ICD users are free to move within the specified communication range of the computing device, which can be actively regulated. The envisioned ICD has no moving parts and no screen, and hence is easily engineered to be sturdy enough to withstand the needs of the applications. For example, in a hospital setting, the ICD may need to withstand a drop of at least four feet.

Other advantages of the present invention include the ability to use writing, drawing, or painting implements to control a computing device with form or surface specificity. This is accomplished by combining writing implement location capture with form or surface identification, through means such as barcoding or RFID. Other benefits arise from the provision of restricted vocabularies of characters, words, symbols or drawings specific to individual fields within forms, which may be further customized for individual users and uses.

Possible uses for the present invention include, but are not limited to, any form-based information system, such as electronic medical records (EMR) data entry, rapid order taking in restaurant or other consumer-sales interaction, inventory and manufacturing process control, insurance or any kind of order fulfillment, invoicing activity, factory process and automation, government security needs, and control of computing devices, including both applications resident in the computing device and online work.

The present invention therefore provides a forms-based real-time human-computer interface that combines handwriting interaction and touch screen-like input capabilities, providing for interactive data entry and control tasks that have previously required keyboard or mouse input. Each of the various embodiments described and/or depicted above and in the following pages and accompanying drawings may be combined with other described embodiments in order to provide multiple features. Furthermore, while this section describes a number of separate embodiments of the apparatus and method of the present invention, what is described herein is merely illustrative of the application of the principles of the present invention. Other arrangements, methods, modifications, and substitutions by one of ordinary skill in the art are therefore also considered to be within the scope of the present invention.

What is claimed is:

1. A method for user-computer interaction, comprising the steps of:
detecting pen-based user input onto at least one identified form, each identified form having a known structure with at least one predefined input field, the step of detecting including detecting an input location relative to the structure of the identified form;
capturing the detected user input to obtain an input content;
classifying the detected and captured input to obtain an input type; and
based on the input type, performing at least one of the steps of:
executing a command;
providing an information display;
performing mark recognition on the captured input to obtain interpreted input; and
performing handwriting recognition on the captured input to obtain interpreted input.

2. The method of claim 1, wherein the step of classifying utilizes the location of the detected input.

3. The method of claim 2, wherein the step of classifying further utilizes the content of the detected input.

4. The method of claim 1, further comprising the step of:
if interpreted input has been obtained, performing at least one of the steps of:
storing the interpreted input in a database;
supplying the interpreted input to an application program; and
displaying the interpreted input.

5. The method of claim 4, further comprising the step of providing a facility for editing the interpreted input.

6. The method of claim 1, further comprising the step of providing a facility for definition of a new identified form.

7. The method of claim 1, wherein at least one predefined form input field is associated with a limited set of valid input content.

8. The method of claim 7, further comprising the step of rejecting captured input at the location of a predefined form input field that is not valid input content for that predefined form input field.

9. The method of claim 1, further comprising the step of detecting which identified form is being used from among a set of possible identified forms.

10. A method for automatically entering the content of pen-based data into a computer-based application, comprising the steps of:
detecting the location of a pen-based data entry on at least one defined form, each defined form having a known location structure and at least one input field within that known location structure;
capturing the pen-based data entry to obtain an entry content;
based on the detected entry location, identifying the input field at that location;
based on the identified input field, performing content recognition on the entry content to obtain an interpreted entry; and
supplying the interpreted entry to the computer-based application.

11. The method of claim 10, further comprising the step of displaying the interpreted entry to a user for verification.

12. The method of claim 11, further comprising the step of permitting user modification of the interpreted entry.

13. The method of claim 10, further comprising the step of the step of detecting which defined form is being used from among a set of possible defined forms.

14. The method of claim 10, further comprising the step of permitting user definition of a new defined form.

15. The method of claim 10, wherein at least one form input field is associated with a limited set of valid entry content.

16. The method of claim 15, further comprising the step of rejecting entry content at a form input field that is not valid entry content for that form input field.

17. A forms-based computer interface, comprising:
a writing implement, the location and content of an entry made by the writing implement being detectable and capturable by automatic means;
an input and control device, comprising:
a writing surface, the writing surface being configured to hold at least one form requiring data input;
at least one location detection device for detecting the location on the form of at least one entry made by the writing input; and
at least one content capture device for capturing the content of the detected entry; and
an input processing system, the input processing system comprising:
a facility for receiving the location and content of the captured entry; and
a facility for recognizing and interpreting the content of the captured entry, based on the entry location, in order to obtain an interpreted entry.

18. The interface of claim 17, wherein the input processing system resides on the input and control device.

19. The interface of claim 17, wherein the input processing system resides on a host computer and the input and control device further comprises a communications device for communicating the detected and captured entry to the host computer for processing in the input processing system.

20. The interface of claim 17, wherein the input processing system further comprises a facility for editing of an interpreted entry.
